(19) United States
(12) Patent Application Publication
(10) Pub. No.: US 2026/0218888 A1
(43) Pub. Date: Jul. 30, 2026

(54) WORK LIGHT

(71) Applicant: Streamlight, Inc., Eagleville, PA (US)

(72) Inventors: Brian ORME, Phoenixville, PA (US); Raymond L. SHARRAH, Collegeville, PA (US); Jonathan R. SHARRAH, Phoenixville, PA (US); Matthew B. DALTON, Elkins Park, PA (US); Ethan Locke WHITE, Philadelpha, PA (US); Joshua D. HAWK, Limerick, PA (US); Gregory A. ROSHAK, Norristown, PA (US); Aidan James Harbison, Lambertville, NJ (US); Peter Paranych Lewis, Philadelphia, PA (US); Samuel Dorvil, Pembroke Pines, FL (US); Isabella Gitto, Schenectady, NY (US)

(21) Appl. No.: 19/463,885

(22) Filed: Jan. 29, 2026

Related U.S. Application Data
(60) Provisional application No. 63/751,105, filed on Jan. 29, 2025.
(60) Provisional application No. 63/783,544, filed on Apr. 4, 2025.

(51) Int. Cl. F21V 21/096; F21L 4/02; F21V 21/088; F21V 21/18; F21V 21/22; F21V 21/28; F21V 21/30; F21W 131/10; F21W 131/402; F21Y 103/10

(52) U.S. Cl. CPC F21V 21/096; F21L 4/02; F21V 21/088; F21V 21/18; F21V 21/22; F21V 21/28; F21V 21/30; F21W 2131/1005; F21W 2131/402; F21Y 2103/10

(57) ABSTRACT

A light for illuminating a work space may comprise: plural elongated members each having a first end and a second end; a light source on or attachable to at least one of the elongated members; and respective hooks fastened to the second ends of the elongated members. The light may include a coil spring fastened between the respective first ends of the elongated members or may include end assemblies of adjacent side-by-side housings that engage each other housing for slidable relative movement. Elongated members may include a steel strip on a side thereof. The light may include a telescoping extension biased to retract into an outer housing.

This Application claims the benefit and priority of U.S. Patent Application 63/783,544 filed Apr. 4, 2025, entitled “WORK LIGHT,” and of U.S. Patent Application 63/751,105 filed Jan. 29, 2025, entitled “WORK LIGHT,” each of which is hereby incorporated herein by reference in its entirety for any and all purposes.

The present invention relates to a work light, and, in particular, to an extendable work light suitable for working on large objects.

The quintessential traditional work light has a cylindrical handle with a socket for an incandescent lamp at one end, and a protective cage to surround and protect the lamp. Typically about half of the cage is a solid panel to partially direct the light from the lamp in a desired direction. A hook is provided at the distal end of the cage so that the light can be hung on an available object and the hook can be rotated 360 degrees for orienting the light to direct light in the desired direction. A power cord exits the bottom of the handle for connecting to an electrical power source.

Unfortunately, those traditional work lights were difficult to position to direct light in the desired direction and because they were hanging lights, the light would usually be directed at least in part in a sidewards direction and not necessarily downward to a work site. In addition, the power cord, while sometimes useful to pull the work light into an orientation to better direct its light, was often in the way of the worker.

Battery operated work lights remedied some of those problems, but they often took a form similar to the above traditional work light with its advantages and disadvantages.

U.S. Pat. No. 8,870,408 entitled “Portable Light and Work Light Adapter Therefor,” assigned to Streamlight, Inc., of Eagleville, Pennsylvania, USA, discloses light having a cylindrical flashlight body and a blade-like light bar light-emitting arrangement extending from the forward end thereof, thereby overcoming many of the disadvantages of the traditional work light. It employs an elongated circuit board assembly wherein a plurality of light emitting devices, e.g., light emitting diodes (LEDs), are mounted on one side of a generally planar electrical circuit board. This light is a great improvement over the traditional work light.

U.S. Pat. No. 8,777,446 entitled “Portable Light Having a Rotatable Head,” assigned to Streamlight, Inc., of Eagleville, Pennsylvania, USA, discloses a light of a different sort that has a light source that is mounted atop a light body and that can be pivoted 180 degrees and rotated 360 degrees relative to the light body so that light can be directed in a wide range of directions. That light also has a hook that is movable along its body and over a wide range of angles to facilitate it being hung in a convenient location; it also has one or more magnets by which it can be magnetically held by a steel or iron object. This light is a great improvement over the traditional work light. However, modern vehicles often have a sound-absorbing pad mounted to the underside of the hood, and/or have hoods that are made of aluminum, carbon fiber or other composites, or other non-magnetic materials, which interfere with or preclude attaching a light to the hood using magnets.

Working in an automotive space, e.g., under the hood of a vehicle, presents a unique set of challenges for the worker and for the work light. The work space is often tight and it can be difficult to place a conventional work light in that space where it illuminates the work object while not being in the way of the worker or a tool. Further, a light that is configured to light the under-hood space in general would be relatively large and thus difficult and inconvenient to transport and to store when not being used.

The conventional under-hood work light is basically a light source affixed to or contained within an elongated, adjustable length pole with hooks on either end. The pole and hooks are arranged so that they can be clipped on either edge of a raised vehicle hood so that the light source illuminates the entire working area of an engine that requires some service or repair.

Conventional work lights of this genre that are hinged for storage typically have molded plastic hinges that are fragile and easily damaged or broken in these work spaces, and so are not as strong and robust as mechanics and the work environment require.

One particular weakness in conventional work lights concerns the issue of foldability. Specifically, it is advantageous for some example lights in this category to be able to be folded, e.g., in half, so that they can fit into a normal sized, locking tool chest. Many automobile mechanics must purchase and maintain their own, personal sets of tools, which are returned to the individual's personal tool chest and locked at the end of the work shift. Any items that can't be locked in a personal tool chest are likely to be “borrowed” and/or lost. So some under-hood lights that can't be folded up and locked in a tool chest at the end of the day is may be “borrowed” or otherwise “disappear” with normal use.

There are also considerable deficiencies in the durability of current foldable work lights and their resistance to grime, oil, grease and other environmental hazards during normal use. For example, current foldable under-hood lights use a hinge of injection molded plastic, which means that any small amount of force applied to the joint in an incorrect location or direction may cause the plastic to crack, ending the useful life of the entire work light. Current foldable under-hood lights with plastic parts are also difficult to clean and service. This is a particular problem with under-hood lights, as the light's normal location is often covered with oils, grease, gasoline, dirt and other contaminants that cannot be easily wiped off the light surfaces. Having an under-hood light that is cleanable and repairable, with easily serviced parts, would be particularly advantageous.

Some conventional lights may have light sources providing different kinds of light, e.g., spot beams and flood beams. However, these lights are generally limited in their flexibility in being configured by a user to better adapt different types of light sources and the locations at which they may be positioned on a work light support to address the user's specific needs in customizing the arrangement of light sources and in illuminating difficult to light work spaces.

Applicant believes there is a need for a work light that is particularly configured to facilitate working in an under-hood automotive work space and/or that there is also a need for a light that can be attached to a raised hood, trunk lid or another part of a vehicle, as well as embodiments that are configurable by a user to address a specific lighting need.

Further, it would be desirable if such light could generally light a significant portion of an under-hood compartment or similar space. It would also be desirable if such light could also be compact for convenient storage, e.g., in a tool chest or toolbox, and/or could facilitate directing light in a particular direction. Ruggedness and durability are also thought to be desirable features for such lights. The ability to clean, service and repair the light would also be desirable qualities.

Accordingly, a work light may comprise: plural elongated members movably disposed to be movable into deployed and collapsed positions, each having a distal end; one or more of the elongated members having an elongated steel strip along one elongated surface thereof; one or more detachable light sources that are attachable to the plural elongated members; respective hooks fastened to distal ends of two of the plural elongated members.

light for illuminating a work space may comprise: plural elongated housings disposed side-by-side, each having a first end and a second end; a light source on an exterior surface of at least one of the elongated housings; an end assembly at the first end of each of the plural elongated housings, each end assembly including an engaging member for slidingly engaging another of the elongated housings; and first and second hooks fastened to the respective second ends of at least two of the elongated housings.

Also a work light or light for illuminating a work space may comprise: a pair of elongated housings each having a first end and a second end; a light source on an exterior surface of at least one of the housings; a coil spring fastened to the respective first ends of the housings; and first and second hooks fastened to the respective second ends of the housings.

Further, a light for illuminating a work space may comprise: plural elongated housings each having a first end and a second end; a light source on an exterior surface of at least one of the elongated housings; one or more coil springs fastened to the respective first ends of the elongated housings; and first and second hooks fastened to the respective second ends of the housings.

Also, a light for illuminating a vehicle having a hood striker may comprise: a light source; and a latch configured for grasping and releasing a hood striker.

In summarizing the arrangements described and/or claimed herein, a selection of concepts and/or elements and/or steps that are described in the detailed description herein may be made or simplified. Any summary is not intended to identify key features, elements and/or steps, or essential features, elements and/or steps, relating to the claimed subject matter, and so are not intended to be limiting and should not be construed to be limiting of or defining of the scope and breadth of the claimed subject matter.

### BRIEF DESCRIPTION OF THE DRAWING

The detailed description of the preferred embodiment(s) will be more easily and better understood when read in conjunction with the FIGURES of the Drawing which include:

FIG. 1 is a perspective view of an example embodiment of a work light according to the present arrangement; FIGS. 1A, 1B and 1C are perspective views of example embodiments of an example work light housing according to the present arrangement in a deployed configuration for being used and in a non-deployed collapsed configuration for storage or transport; and FIGS. 1D and 1E are cross-sectional views thereof at two different locations;

FIG. 2 is an exploded view of the example embodiment of FIGS. 1-1E;

FIG. 3 is a perspective view of an example embodiment of a work light having plural example detachable light sources thereon, and FIGS. 3A-3G are illustrations of the example detachable light sources of FIG. 3;

FIG. 4 is a view of example embodiments of alternative elongated light sources suitable for use in the example light, and FIGS. 4A and 4B illustrate an example embodiment for a deployable elongated light source;

FIG. 5 is a is a schematic diagram of an example electrical circuit suitable for use in the example light;

FIGS. 6A through 6D illustrate a further example embodiment of a work light having an exoskeleton spring joint and other advantageous features;

FIGS. 7A through 7D illustrate examples of alternative molded and linked “drag chain” exoskeleton members for a spring joint;

FIGS. 8A and 8B are each perspective views of an example embodiment of a work light according to the present arrangement in a deployed configuration as for being used, FIG. 8C illustrates two side views and a cross-sectional view of the example light of FIGS. 8A-8B; and FIGS. 8D and 8E are perspective views of the example light in a non-deployed folded configuration for storage or transport;

FIGS. 9A and 9B are cross-sectional views thereof at two different locations along its length illustrating the arrangement of a coil spring joint thereof and of an example user interface thereon, respectively;

FIGS. 10A through 10D illustrate alternative example embodiments of hooks 400 that are convenient for stowing the example work light, and FIGS. 10E and 10F are illustrations of hooks having an associated handle for the example light;

FIGS. 11A and 11B include perspective views of another example embodiment the work light 100 in collapsed and extended states and FIG. 11C is an enlarged perspective view of an end of the example work light 100; and FIGS. 12A through 12D are cross-sectional views of the example work light 100 of FIG. 11 A-11C;

FIG. 13 illustrates an example of an alternative configuration of example work light 100 configured to utilize the hood striker and/or another vehicle part, and FIGS. 13A and 13B illustrate an example embodiment of a hood striker attachment arrangement therefor; and

FIG. 14 includes perspective views of the example work light in collapsed and extended states.

In the Drawing, where an element or feature is shown in more than one drawing figure, the same alphanumeric designation may be used to designate such element or feature in each figure, and where a closely related or modified element is shown in a figure, the same alphanumerical designation may be primed or designated “a” or “b” or the like to designate the modified element or feature. Similar elements or features may be designated by like alphanumeric designations in different figures of the Drawing and with similar nomenclature in the specification. As is common, the various features of the drawing are not to scale, the dimensions of the various features may be arbitrarily expanded or reduced for clarity, and any value stated in any Figure is by way of example only.

### DESCRIPTION OF THE PREFERRED EMBODIMENT(S)

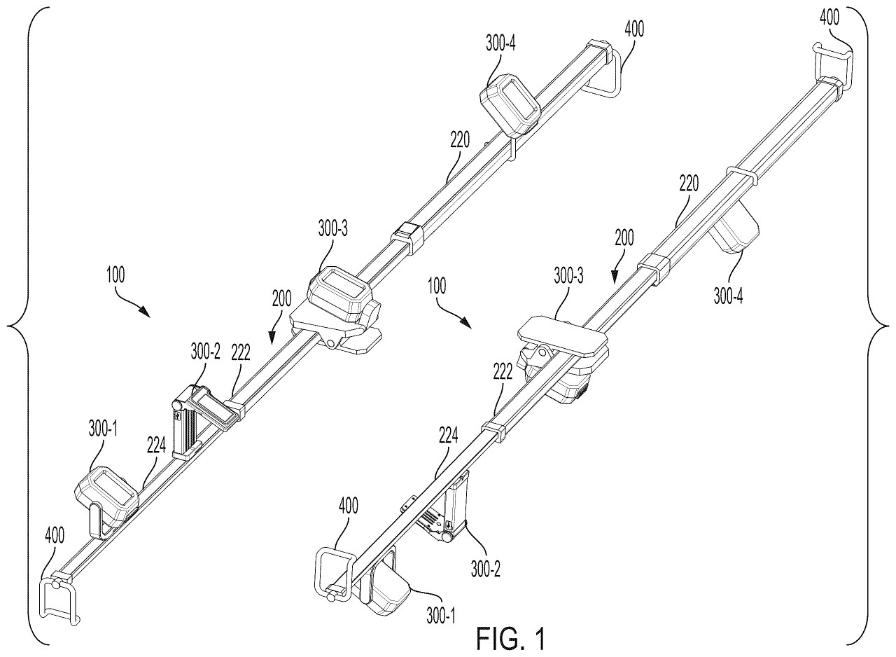

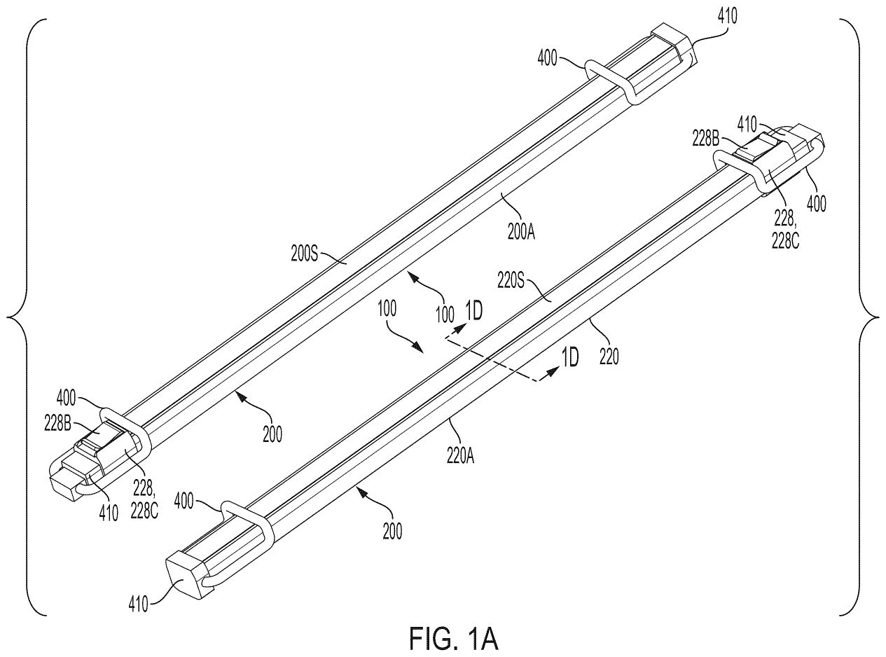

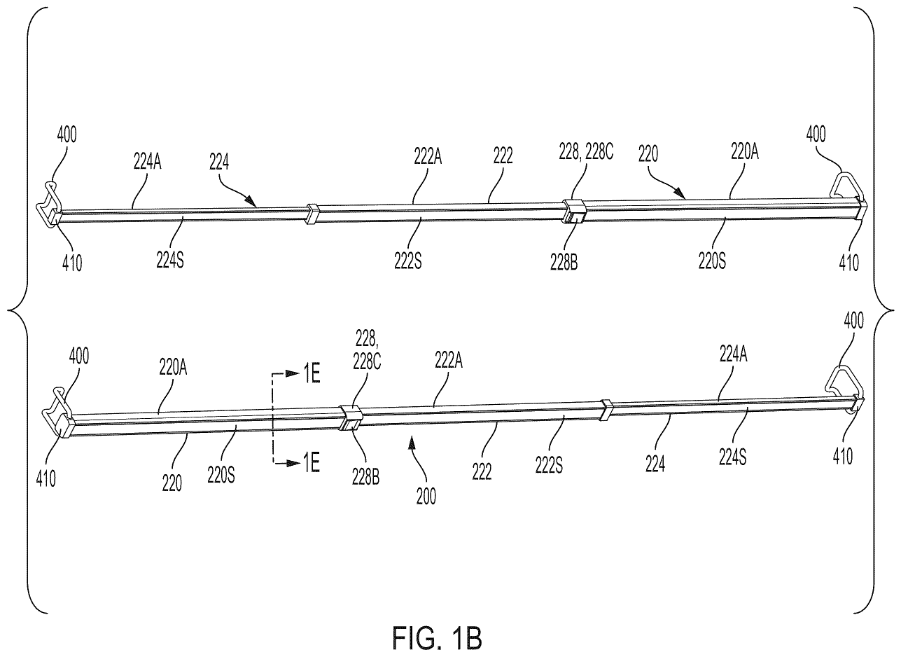

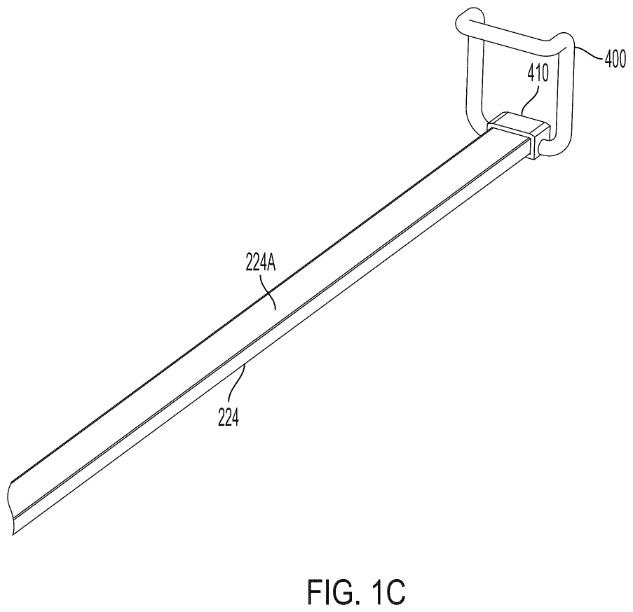

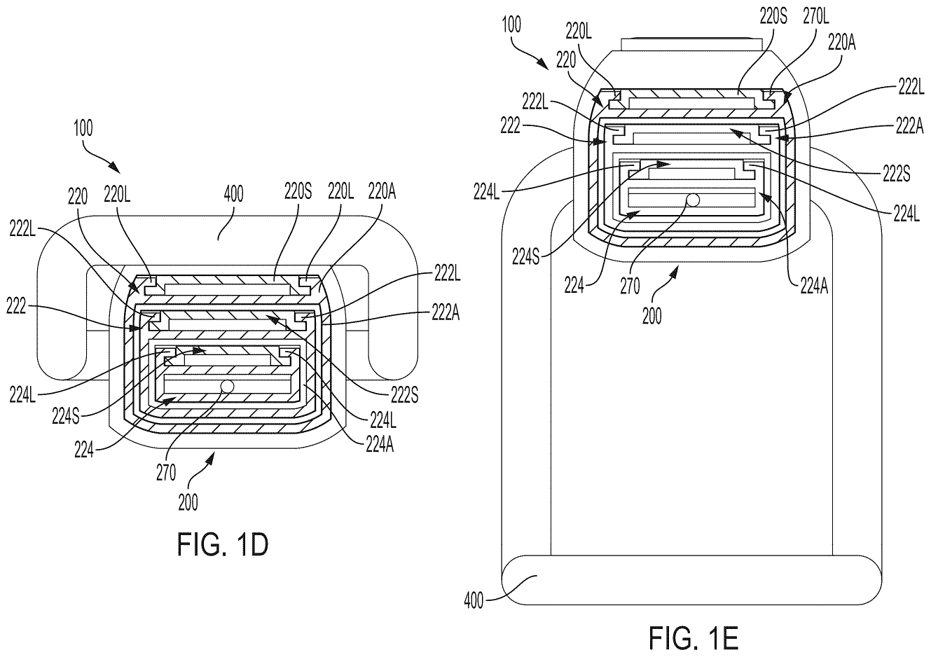

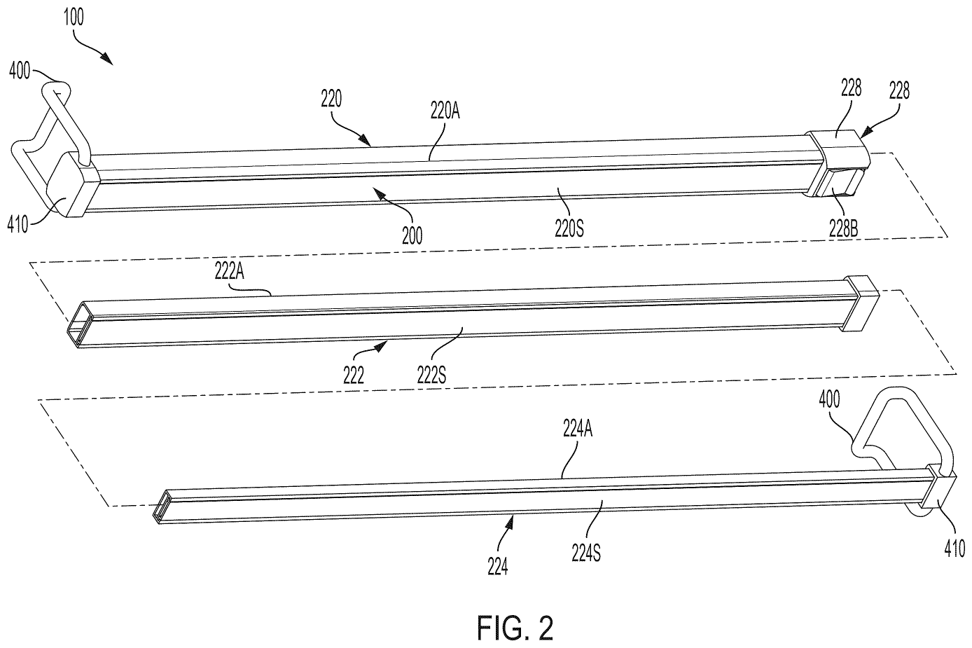

FIG. 1 is a perspective view of an example embodiment of a work light 100 according to the present arrangement; FIGS. 1A, 1B and 1C are perspective views of example embodiments of an example work light housing 200 according to the present arrangement in a deployed configuration for being used (e.g., FIG. 1B) and in a non-deployed collapsed configuration (e.g., FIG. 1A) for storage or transport; and FIGS. 1D and 1E are cross-sectional views thereof at two different locations; and FIG. 2 is an exploded view of the example embodiment of FIGS. 1-1E.

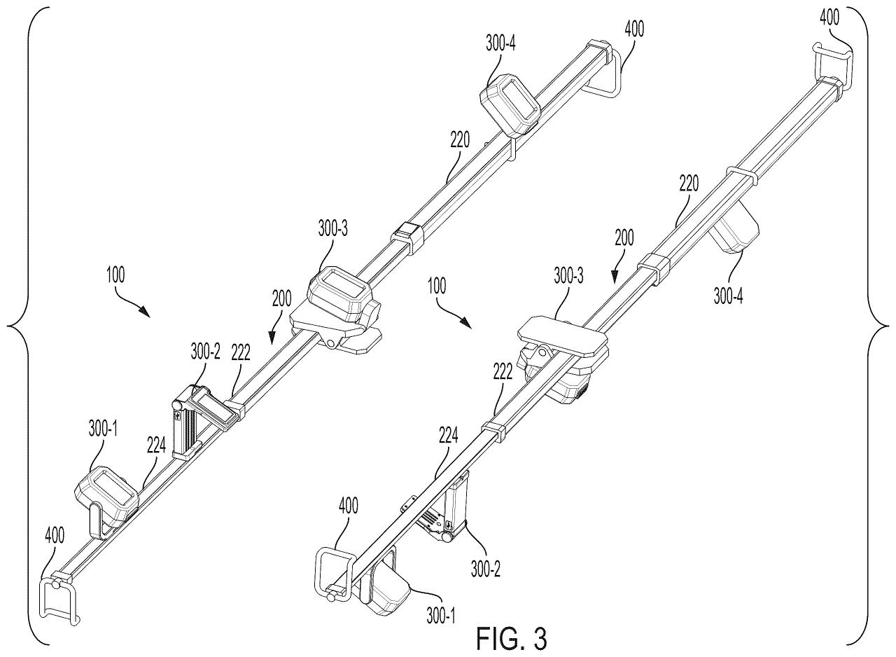

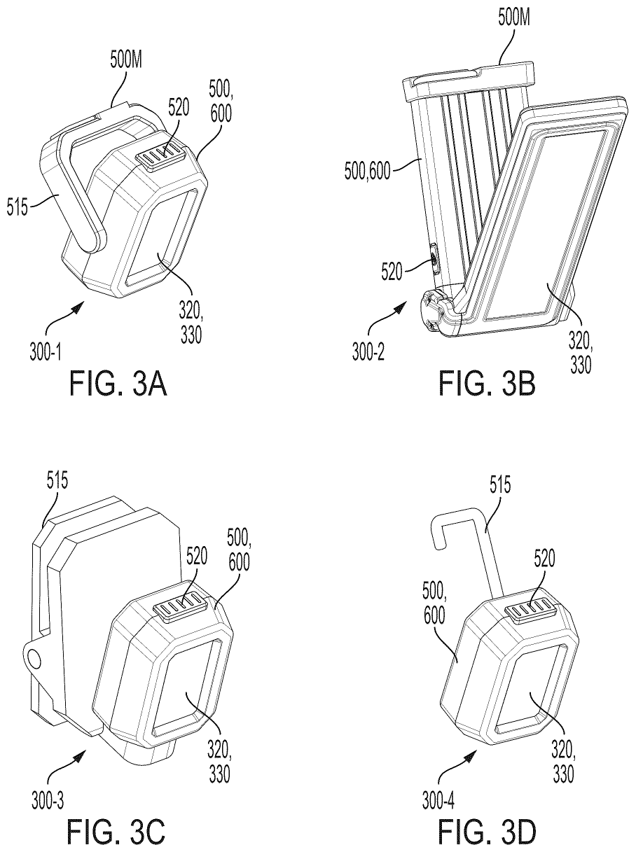

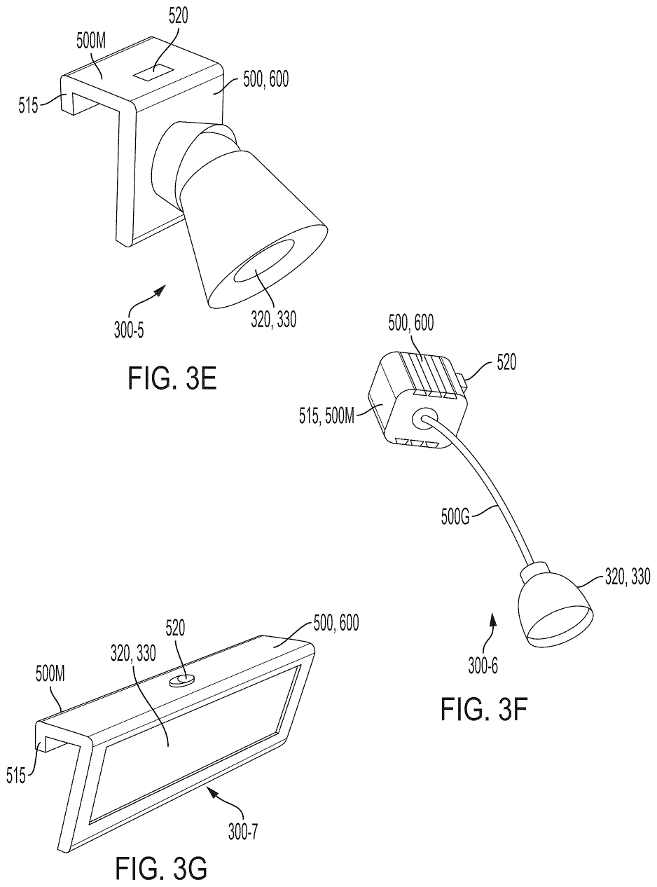

Work light 100, also referred to as a lighting device 100 or as a light 100, includes a housing 200 that includes plural housing members, e.g., housing members 220, 222, 224, that are extendible for use and are collapsible for storage and transport. A grasping device 400, e.g., a hook 400, is provided at each end of housing 200, at the distal ends of its housing members 200, 220, 224 when extended, for attaching light 100 to an object with which it is used, e.g., a hood or other part of a vehicle or another object. As shown in FIG. 3, one or more light sources 300 are attached to housing 200 for illuminating an object with which light 100 is used, e.g., a work space. The terms housing and housing 200 are intended to refer to any and all of the housings and parts thereof described herein, unless the context indicates otherwise.

One or more light sources 300 may be affixed to housing 200 or may be attachable to and removable from housing 200. Attachments therefor may include brackets, clamps, fasteners, magnets, hook-and-loop fasteners, and the like as may be thought suitable and desirable for a particular use of a light 100. A source of electrical power 600 and a user interface 500 may be associated with housing 200, 220, 222, 224, e.g., when the light source 300 is permanently affixed to housing 200, 220, 222, 224, and/or with a light source 300 itself, e.g., when the light source 300 is removable by a user from housing 200 to be utilized separately.

One embodiment of work light 100 comprises a housing 200 that includes two or more housing members 220, 222, 224 that are configured to telescope one into the other. Each housing member 220, 222, 224 preferably includes an elongated aluminum part 220A, 222A, 224A that defines a “track” along one side thereof in which an elongated steel plate 220S, 222S, 224S is disposed. Each steel plate 220S, 222S, 224S is preferably of a material to which a magnet will adhere, e.g., a steel material. A ferritic steel is preferred.

Ferritic stainless steels are a family of stainless steels with a body-centered cubic (BCC) crystal structure and composed primarily of iron and chromium. They are characterized by being magnetic, non-hardenable by heat treating, and having excellent resistance to stress-corrosion cracking (SCC). Ferritic stainless steel alloys are designated as part of the 400-series of stainless steels in the SAE numbering system for grades of steel.

As used herein, the terms “aluminum” and “steel” indicate examples of materials that might be utilized in some embodiments of this arrangement, but these materials are not required, and any material or combination of materials having suitable physical characteristics may be utilized. Steel strip 220S, 222S, 224S may be an elongated magnetic or magnetically receptive material.

Elongated aluminum parts 220A, 222A, 224A are preferably a hollow extrusion having a cross-sectional shape selected to provide suitable strength and stiffness, e.g., triangular, square, rectangular, trapezoidal, hexagonal, circular, oval, elliptical and the like. Aluminum, magnesium and plastic are example materials therefor, and extruded aluminum is presently preferred. Opposing elongated shaped inward-facing parallel flanges 220L, 222L, 224L on a side of each of elongated parts 220A, 222A, 224A define respective tracks into which elongated steel plates 220S, 222S, 224S are disposed.

Elongated aluminum parts 220A, 222A, 224A are preferably of respective cross sectional sizes so the elongated interior space thereof receives the next smaller housing part such that the housing parts 220, 222, 224 slide easily one relatively to each other for telescoping outwardly to provide an extended or deployed configuration for use and also slide easily one into the other for telescoping inwardly to provide a compressed or non-deployed configuration for storage or transport. The cross-sectional sizes are sufficiently close such that the work light 100 is relatively rigid when extended. This ability to slide feature allows the light to be compressed for storage and then extended to different lengths to be attached to a variety of different vehicle hoods and other objects. Since there is no hinge in the center, work light 100 is substantially rigid and will not “sag” at its center when extended and suspended in a hanging orientation.

A preferred form of flanges 220L, 222L, 224L has an L-shaped cross-section which provides robust support for elongated steel plates 220S, 222S, 224S. Preferably, elongated steel plates 220S, 222S, 224S have a complementary cross-sectional shape to the flanges and tracks in which they are disposed, e.g., such that the surface of the side of housing members 220, 222, 224 including elongated steel plates 220S, 222S, 224S present a substantially smooth surface, for receiving a magnetically mountable device, e.g., a lighting device, thereon. To that end, elongated steel plates 220S, 222S, 224S preferably have a “proud” or “top-hat” shaped cross-section as in the example thereof illustrated.

Elongated steel plates 220S, 222S, 224S may be retained in their respective tracks on sides of housing members 222, 224, 226 by any convenient means. Suitable examples thereof include deforming the flanges 220L, 222L, 224L, e.g., by heating, compressing, crimping or peening the flanges, by adhesive, by a tight frictional fit, by one or more fasteners, and the like.

Elongated steel plates 220S, 222S, 224S may extend over a substantial portion of the length of housing members 220, 222, 224, and preferably over substantially the entire length of each one thereof, e.g., over the substantially the entire exposed lengths thereof when fully extended or deployed. While steel strips 220S, 222S, 224S are typically not magnetized, they may be magnetized if desired, e.g., to provide a place to hold, e.g., wrenches, screwdrivers, pliers, nuts and bolts and other tools and objects that are made of steel.

Housing members 220, 222, 224 may be biased to retract inwardly towards their collapsed or non-deployed configuration which tends to aid hooks 400 grip onto an object to which work light 100 is attached. Suitable biasing members 270 include, e.g., one or more springs, helical springs, bungee cords, and other elastic materials, the ends of which are attached to the outermost housing member, e.g., housing member 200, and to the innermost housing member, e.g., housing member 224, typically at the distal ends thereof. Biasing member 270 is typically internal to light 100, e.g., internally to housings 200, where it is protected from physical damage and contamination.

A latch and release 228 may be provided on work light 100, e.g., on an end of outer housing member 220, and may comprise a collar part 228C and a release and/or latch button 228B, and may be configured to retain work light 100 in a collapsed or non-deployed configuration by, e.g., cam lever, friction or a pin or another mechanical restraining member. Latch and release 228 may also be configured to retain work light 100 in, e.g., a fully extended or deployed configuration, or in any desired position between the collapsed and fully deployed configurations.

Advantageously, work lights 100 including housings 200 of the sort described above are configured to provide great flexibility to users by their being configured to receive a wide variety of types and kinds of devices, e.g., lighting devices, at different locations thereon and in different orientations, all by a simple and convenient magnetic attachment arrangement.

Housing 200 has a hook 400 at each of its distal ends, e.g., at the distal ends of housing parts 220 and 224 in the illustrated example embodiment, for engaging an object, e.g., a vehicle hood, to which light 100 is attached for providing light on a work space. Hooks 400 may be provided with detents to retain them in one or more desired positions and/or a spring to bias the hook 400 towards a desired position.

Work light 100 may also be referred to as an under-hood light 100 because it is suitable for use in an automotive environment, particularly where the light is suspended below and supported by an a vehicle's raised hood panel. However, lights 100 described herein may be used in any other environment where their configuration and lighting capability can be useful.

Housing 200 and hooks 400 thereof are arranged so that they can be placed over the opposing edges of a raised vehicle hood so that one or more light sources 300 mounted thereon can illuminate the entire working area and/or specific areas of an engine that requires some service or repair. Hooks 400 may be configured to be closely disposed adjacent to housing 200 when in their stowed position, so that the profile of light 100 is not substantially enlarged by hooks 400. Such hook 400 may have a relatively thin and flat portion between the ends that pivot in connection 410 and may have spaced apart hook ends that straddle housing 200.

In addition, the example light 100 can also be used in locations other than under a vehicle hood including, but not limited to attaching to the underside of a vehicle, a vehicle trunk lid, another door of a vehicle, spanning the inner portion of a vehicle, e.g., by engaging hooks 400 with the front seats or back seats thereof or by opening opposite doors and engaging hooks 400 with the door jambs. Further, light 100 can be hung vertically or at any angle on a wall, pipe, or other structure whether adjacent to a vehicle or not, or light 100 can stand in a folded (storage) position on a horizontal surface to illuminate an area or the side of a vehicle.

To attach light 100 to a vehicle hood or other part, the user pulls hooks 400 apart against the force of the biasing member 270 to spread the hooks 400 apart to fit around the edges of a raised vehicle hood or other object. Then releasing the hooks 400 or relaxing the tension thereon will move hooks 400 toward the edges of the raised hood or other object and to remain in position thereon due to the tension provided by the biasing member 270 and friction between hood edges and the hooks 400.

Hooks 400 of light 100 are also preferably rotatable with respect to housing 200 and what ever light source or sources 300 may be attached thereon, e.g., about the longitudinal axis of housing 200, so that when hooks 400 engage the edges of a hood or trunk lid, the housing 200 and the light sources 300 thereon, can be rotated to various angles so that the light sources 300 can be oriented to face and provide lighting to the desired areas. Rotation of hooks 400 may be unlimited, that is, through a complete 360 degrees of rotation or more, or may be limited to a smaller value, such as 45, 90 or 180 degrees of rotation, as may be desirable.

Further, hooks 400 are also preferably pivotable relative to the longitudinal axes of housings 200, e.g., so that they can be pivoted to facilitate their engaging a vehicle part, e.g., a hood or trunk lid, as well as being pivoted to a desired position for storing light 100 and/or for standing light 100 on its hook end when housing 200 is collapsed. Light 100 may also include a strap, clip, lock or some other retaining mechanism for releasably securing the hooks 400 in a bent or folded position and/or a spring or similar mechanism for biasing the hooks 400 in an extended position.

Alternatively, the light 100 may also include a spring or similar mechanism for biasing the hooks 400 in a bent or folded position, so that the hooks 400 must be unfolded against the resistance of the spring or biasing mechanism in order to secure the hooks to the edges of a vehicle's hood or other object. The hooks 400 may be folded and/or rotated to alternative positions for storage of the light 100 when not in use; the folding and/or rotation of the hooks 400 may reduce the total length and/or cross dimension of light 100, further facilitating storage of the light. Straps, hooks, clips, locks or some other retaining mechanism may also be incorporated into the light 100 to releasably secure the housing portions of the light in a collapsed position, facilitating the storage and transport of the light.

In a preferred arrangement, each hook 400 is supported on the end of housing 200 by a hook connector 410 which includes at least a pivot joint facilitating hook 400 being pivotable relative to housing 200. It is also desirable that hook 400 be rotatable relative to the longitudinal axis of housing 200. To that end, connector 410 may also include a rotating joint whereby hook 400 is rotatable about the longitudinal axis of housing 200.

Hooks 400 may be covered with padding or a soft compliant material so that they do not chip, scratch or otherwise damage the, e.g., painted surfaces and edges of the hood or other object. Hooks 400 have a rigid hook structure and/or have a rigid hook structure covered by a resilient pad or covering to reduce the likelihood that a part of an auto or a part of another object to which light 100 is attached is scratched or otherwise damaged by light 100.

FIG. 3 is a perspective view of an example embodiment of a work light 100 having plural example detachable light sources 300 thereon, and FIGS. 3A-3G are illustrations of the example detachable light sources 300 of FIG. 3. Therein the example detachable light sources 300 each is a lighting device 300 of a different configuration and/or having different means of attachment to a light housing 200, e.g., to the example housing 200 of FIG. 1 through FIG. 2, as well as other example embodiments of a housing including the example embodiments of housings 200 described herein. The terms light source and light source 300 are intended to refer to any and all of the light sources and parts thereof described herein, unless the context indicates otherwise.

Examples of light sources 300 that are aimable and/or positionable may include, e.g., a spot lamp on a gooseneck stalk (see FIG. 3F) or a light in an “eyeball” socket (e.g., like an airplane reading light; see FIG. 3E), either fixedly mounted on or removably/detachable from housing 200, 220, 222, 224. Detachable light sources 300 may employ a magnet or magnetic base 500M so as to be mountable magnetically to a steel strip 200S, 220S, 222S, 224S or other steel part of housing 200, 220, 222, 224 and/or to any metal surface to which a magnet will cling when removed from a housing member, including a steel strip, or may employ a clamp or clip or hook or a similar attaching member. Detachable light sources 300 can and in many cases preferably do include an electrical power source 600 and a user interface 500 so as to be functional as a light when removed from light 100, as do each of example light sources 300-1 to 300-7.

A first example embodiment of a detachable light source 300 includes light source 300-1 which has a body that supports a light source 320, 330, a user interface 500 and an electrical power source 600 and an actuator 520 for energizing and de-energizes its light source 320, 330.

Light 300-1 also includes a mounting arrangement 515, e.g., a handle 515, for attaching and detaching light 300-1 from a extendable housing 200, 220, 222, 224. The mounting arrangement in this example being a formed handle having a magnet 500M for attaching to a steel part of housing 220, 222, 224, such as a steel strip 200S, 220S, 222S, 224S thereof. The light body may be attached to the mounting arrangement 515 through a pivotable or rotatable joint, enabling the light source 320, 330 to be rotated or aimed in different directions relative to the mounting arrangement 515.

A second example embodiment of a detachable light source 300 includes a light source 300-2 that have one or more “light bar” light sources 320, 330. “Light bar” refers to elongated light sources that generally produce a relatively broad flood beam such as provided by attachable light 300-2, e.g., the Streamlight® STINGER SWITCHBLADE® or FLIPMATE® lights. Detachable lights like light 300-2 have light bars 320, 330 that are hinged to be positionable over a range of angles, e.g., a 180° range, on its housing 500, e.g., the user interface 500. Light 300-2 has a mounting arrangement 515, e.g., including a magnet 500M, on the base and/or side of user interface 500, power source 600, thereof for attaching to a steel part of housing 200, 220, 222, 224, such as a steel strip 200S, 220S, 222S, 224S thereof.

One or more hinged or pivotable light bars 320, 330 of the sort of those of light 300-2 may be attached to one or more of housing members 200, 220, 222, and/or 224 of light 100. The different hinged light bars 320, 330 can be arranged in the same orientation to direct light to a particular relatively broad area or can be arranged in different orientations to provide light to plural areas as the user desires. Such light bar light sources 300-2 that have magnet 500M on a side or base thereof can be the disposed along housing members 220, 222, and/or 224 in any desired positions so as to direct light in any direction a user might desire. Such light bar sources 300-2 when oriented in their “stowed” positions adjacent to those housing members provide a strip light source 300 as in an elongated work light, yet can be rotated and/or positionable as the user prefers.

Another example embodiment of a detachable light source 300 includes light source 300-3 which has a body that supports a light source 320, 330, a user interface 500 and an electrical power source 600 and an actuator 520 for energizing and de-energizing its light source 320, 330. Light 300-3 also includes a mounting arrangement 515, e.g., a clip or clamp 515 for attaching and detaching light 300-3 from a extendable housing 200, 220, 222, 224. The mounting arrangement in this example being a clip or clamp 515, which may have a fixed connection or a hinged or pivotable connection to user interface 500. Clip or clamp 515 may be spring biased or may employ another tightening arrangement, e.g., a tightening screw.

Another example embodiment of a detachable light source 300 includes light source 300-4 which has a body that supports a light source 320, 330, a user interface 500 and an electrical power source 600 and an actuator 520 for energizing and de-energizing its light source 320, 330. Light 300-4 also includes a mounting arrangement 515 including a hook 515 for attaching and detaching light 300-4 from a extendable housing 200, 220, 222, 224, e.g., hanging therefrom. The hook 515 may be rigidly connected to user interface 500 or may be pivotable thereon, e.g., by a ball and socket arrangement.

Another example embodiment of a detachable light source 300 includes light source 300-5 which has a body that includes a user interface 500 and an electrical power source 600 and an actuator 520 for energizing and de-energizing its light source 320, 330. Light source 320, 330 of light 300-5 is connected to its body, e.g., user interface 500, by a pivotable connection, e.g., as may be provided by a ball and socket connection which facilitates directing light in directions in a substantially hemispherical range. Light 300-5 also includes a mounting arrangement 515 for attaching and detaching light 300-5 from a extendable housing 200, 220, 222, 224. The mounting arrangement in this example being a formed handle 515 or bracket 515 that can fit over housing 200, 220, 222, 224, which may or may not include a magnet 500M for attaching to a steel part of housing 200, 220, 222, 224, such as a steel strip 200S, 220S, 222S, 224S thereof.

Yet another example embodiment of a detachable light source 300 includes light source 300-6 which has a body that supports an elongated flexible shaft 500G, e.g., a gooseneck shaft 500G, that supports light source 320, 330 at a distal end thereof. Its body includes user interface 500, electrical power source 600 and an actuator 520 for energizing and de-energizing its light source 320, 330. Gooseneck shaft 500G may have a fixed length or may be retractable and extendable, e.g., on a reel disposed inside user interface 500. Light 300-6 also includes a mounting arrangement 515 for attaching and detaching light 300-6 from a extendable housing 200, 220, 222, 224, which may be any one or more of the mounting arrangements 515 described herein. The mounting arrangement 515 illustrated in this example includes a magnet 500M for attaching to, e.g., a steel part of housing 200, 220, 222, 224, such as a steel strip 200S, 220S, 222S, 224S thereof.

Another example embodiment of a detachable light source 300 includes light source 300-7 which has a body that supports a flat light bar light source 320, 330, a user interface 500 and an electrical power source 600 and an actuator 520 for energizing and de-energizing its light source 320, 330. Light 300-7 also includes a mounting arrangement 515 for attaching and detaching light 300-7 from a extendable housing 200, 220, 222, 224. The mounting arrangement 515 in this example may be a bracket or formed handle 515 that may or may not include a magnet 500M for attaching, e.g., to a steel part of housing 200, 220, 222, 224, such as a steel strip 200S, 220S, 222S, 224S thereof.

It is noted that any of the mounting arrangements 515 in the foregoing examples may be a magnet 500M, or may be a formed handle or bracket 515, a hook 515 and/or a bracket 515 as may be desirable and that may or may not include a magnet 500M for attaching to a steel part of housing 200, 220, 222, 224, such as a steel strip 200S, 220S, 222S, 224S thereof, or any other suitable mounting arrangement.

Further, FIGS. 3A-3G illustrate examples of detachable light sources 300 for work light 100 that provide a particular kind of light, e.g., a flood light or a spot light or a directionally adjustable light, and may be utilized singly or in any combination of the illustrated lights 300-1 300-7, or any other suitable light, on the same work light 100. Any two of more of the light sources 320, 330 thereof may be associated with a single user interface 500, power source 600 and mounting arrangement 515 to provide a desired combination of flood lighting, spot lighting and/or directionally adjustable lighting from the same light 300, thereby making available two different kinds of illumination in one unit.

An example light 100 of one of the foregoing arrangements may include one or two or more different lighting elements 300 on the one or more housing members 200 thereof. There is the typical “flood” lighting element 300-2 which provides illumination over a broad area, i.e. the light is not focused on any particular area and instead is directed in many different directions, without precise focus or control, to cover the maximum possible area. This is a very useful kind of light for many tasks, and is the kind of light element used on all prior art devices.

The present example embodiment of work light 100 illustrated in FIG. 3 includes a plurality of selected ones of light sources 300-1-300-7 that can provide one or more floodlights and/or one or more spotlights, i.e. spot beams, that can each be adjustably aimed by the user at particular areas within the work space, e.g., an engine compartment.

Light produced by a spot lighting element formed into a beam, e.g., by reflecting and refractive elements and/or lenses, to target a single area of a predetermined size and direction from the spot light 320. These optical elements and/or lenses of the spot light source may be adjustable to change the size of the spot of light in the area that the user desires be illuminated.

There are areas of a workspace, e.g., an engine and engine compartment, that may not be covered by light from the flood light 300, but the direction of the spotlight 300 can be adjusted, i.e. aimed, by the user so that the particular focus of the light's output is directed at the exact location or area that the user desires to illuminate. The spot light sources can be adjustable, i.e. aimable, through ball joints or adjustable stalks; other mechanisms for adjusting the direction of a spotlight would also work with this work light or by changing the position in which a light source 300 is attached, magnetically or otherwise, to a housing 200.

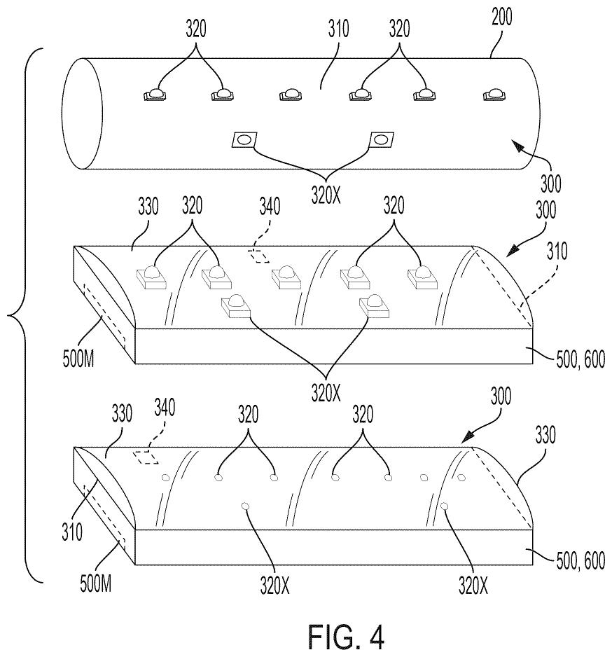

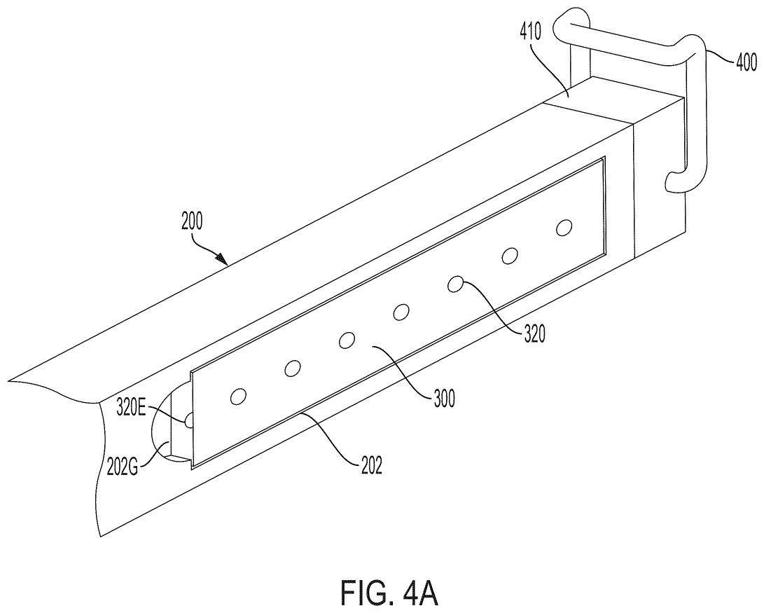

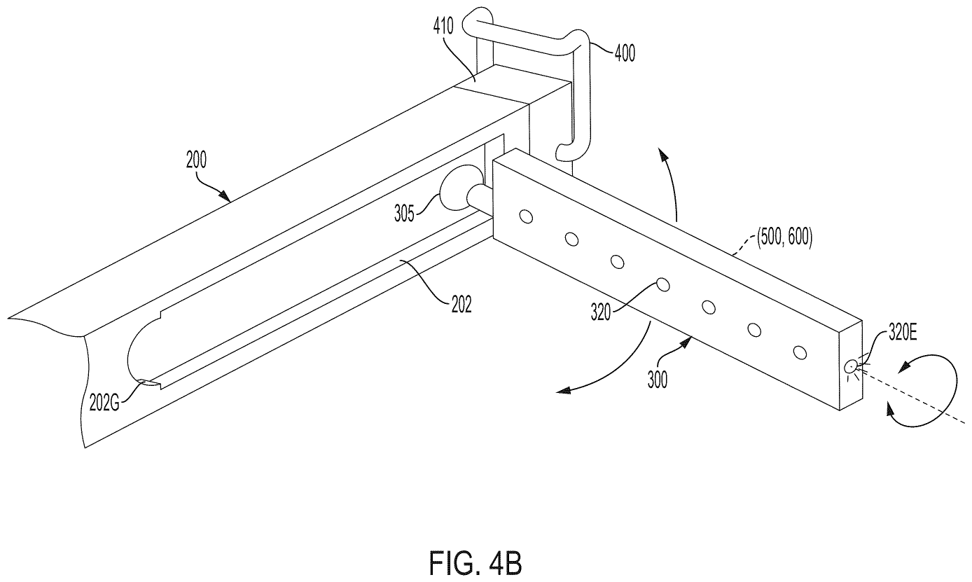

FIG. 4 is a view of example embodiments of alternative elongated light sources 300 suitable for use in the example light 100, and FIGS. 4A and 4B illustrate an example embodiment for a deployable elongated light source 300. These example light sources 300 are considered alternatives, and in a typical embodiment, light sources 300 of the similar configuration are typically provided on each housing member of a light 100, although that need not be the case. In general, elongated light source 300 is preferred to be at least one-half the length of housing 200 and more preferably to be at least two-thirds the length of housing 200, so as to illuminate a relatively broad work area.

Light source 300 in the first example (upper) embodiment is preferably elongated and positioned along the length of each housing 200, e.g., outer housing 220 and additional housing members 222 and/or 224 thereof, oriented so that when the hook 400 ends of light 100 are grasping the edges of, e.g., a raised vehicle hood, light sources 300 are providing illumination in a generally downwards direction, e.g., towards the engine bay, where the user is typically working.

The hook 400 ends of light 100 are also preferably rotatable with respect to the LEDs 300, e.g., about the longitudinal axis of the housing 200 (including one or more members 220, 222, 224 thereof), so that when the hook 400 ends engage the edges of a hood or trunk lid, the housing and the light sources 300 thereon can be rotated to various angles so that the light sources 300 can be oriented to face and provide lighting to the desired work areas.

Light source 300 (i.e. in the upper embodiment of FIG. 4) may and preferably does comprise a plurality of light emitting devices 320, e.g., light emitting diodes (LEDs) 320, that are attached to the exterior of housing 200. In one example, a plurality of packaged LEDs 320 may be arrayed on housing in a desired pattern and connected to each other and to electrical power source 600 by electrical conductors attached to housing 200. LEDs 320 need not all be of the same type and kind, but may be of different colors, produce light of different wavelengths, produce light of different intensities and/or be operated in different operating modes. In this embodiment, housing 200 and/or the members 220, 222, 224 thereof, provide the substrate for light source 300.

In another arrangement (i.e. in the embodiment at center in FIG. 4), substrate 310 includes the aforementioned electrical conductors and an array of packaged LEDs 320 thereon. Therein, substrate 310 is typically an electrical circuit board 310 with printed electrical conductors thereon and with the packaged LEDs 320 being mounted thereon with their electrical leads soldered or otherwise connected to the electrical conductors. Substrate 310 may be a rigid electrical circuit board or may be a flexible electrical circuit board, and may be attached to housing 200 by any suitable fastener or means.

In another preferred arrangement (i.e. in the bottom embodiment of FIG. 4), substrate 310 includes the aforementioned electrical conductors and an array of LED chips 320 thereon. LED chips 320 are surface mounted on substrate 310. Therein, substrate 310 is typically an electrical circuit board 310 with printed electrical conductors thereon and with the LED chips 320 being surface mounted thereon with their electrical contacts soldered or attached by electrically-conductive adhesive or other solder substitute or otherwise connected to the electrical conductors. Substrate 310 may be a rigid electrical circuit board or may be a flexible electrical circuit board, and may be attached to housing 200 by any suitable fastener.

In each of the lower two embodiments of FIG. 4, a transparent or translucent lens 330 is may be provided to cover light source 300, e.g., substrate 310 and LEDs 320, so as to protect them from water, oils and other materials commonly found in industrial, e.g., automotive, work spaces. Lens 330 may be, e.g., a formed plastic lens that fits over substrate 310 and provides space or spaces into which LEDs 320, 320X may extend. Lens 330 may be replaceable by the user, such as a snap-on lens with a curved cross-section and longitudinal edges or ridges that engage with complementary longitudinal recesses positioned at the edges of the light source 300.

The replaceable lens 330 may serve to protect the light source 300 against damage during use and/or may permit the user to adjust the optics of the light source-such as one lens providing for a narrower focus, higher intensity light beam for certain uses and a second lens providing for a wider focus, lower intensity light beam for other uses. For example, a user might choose to replace the narrow focus lens with the wider focus lens to provide a more gentle “flood” light beam to reduce fatigue on the eyes during a work shift. Alternatively, a single lens may include multiple types of lens elements (such as separate spot and flood lens members) over different LEDs 320, which may be selectively activated to provide an overall substantially “spot” or “flood” beam for the light 100 as a whole.

Such lens 330 may have tabs or other features that provide for lens 300 to simply snap into place over substrate 310, which facilitates replacement of a lens 330 that becomes scratched or cracked due to hard use. Alternatively, lens 330 may be a conformal lens of the sort that is formed in place by a flowable material as described in U.S. Pat. No. 10,612,732 entitled “Method for Making a Lighting Device Including an Led Chip-on-board Light Source and Lens” of Streamlight, Inc.

Light emitting devices 320 include those emitting so-called “white” light, preferably having a light spectrum that enables the color of objects to be accurately perceived, which is a matter of safety and accuracy for those working with colored objects, e.g., wires having identifying colored insulation. Light emitting devices 320 providing such color fidelity typically have a CRI of 90 or higher. Typically, such white LEDs 320 are arrayed along the length of elongated light source 300 in a pattern to produce a flood of light of relatively even intensity.

Light emitting devices 320 providing such color fidelity preferably have a Color Rendering Index (CRI) of 90 or higher. Streamlight's Color-Rite® Technology is based on the Color Rendering Index scale of from 0 -100 that indicates how well a light source reflects color variations of illuminated objects as they appear to the human eye. The higher the CRI, the more vibrant the colors appear. On that CRI scale, lights that measure 90+ are considered “high” CRI lights and are critical for tasks requiring the most accurate color discrimination. A perfect 100 CRI would enable a person to see colors as they appear in natural sunlight. Lights having Color-Rite® Technology are available from Streamlight, Inc, of Eagleville, Pennsylvania, USA.

In addition and/or optionally, LEDs 320 producing colored light may be included in light source 300. For example, one or more LEDs 320 producing red light may be included so that light 100 may be used as a marking or safety light or emergency light, e.g., on a disabled vehicle or vehicle being towed. For example, LEDs 320 producing infrared (IR) light and/or ultraviolet (UV) light may be included so that light 100 enables inspections, detection of substances and/or markings not visible under natural light, and for other purposes. These “extra” LEDs 230 are indicated, e.g., by the identification 320X in FIG. 4.

The LEDs 320 of light sources 300 are preferably controlled by a controller and control circuit with functions as described in relation to user interface 500. The controller may be disposed in user interface 500 as described herein. The term controller is intended to encompass any processor, microprocessor, microcontroller and the like suitable for performing the operations described herein and additional operations.

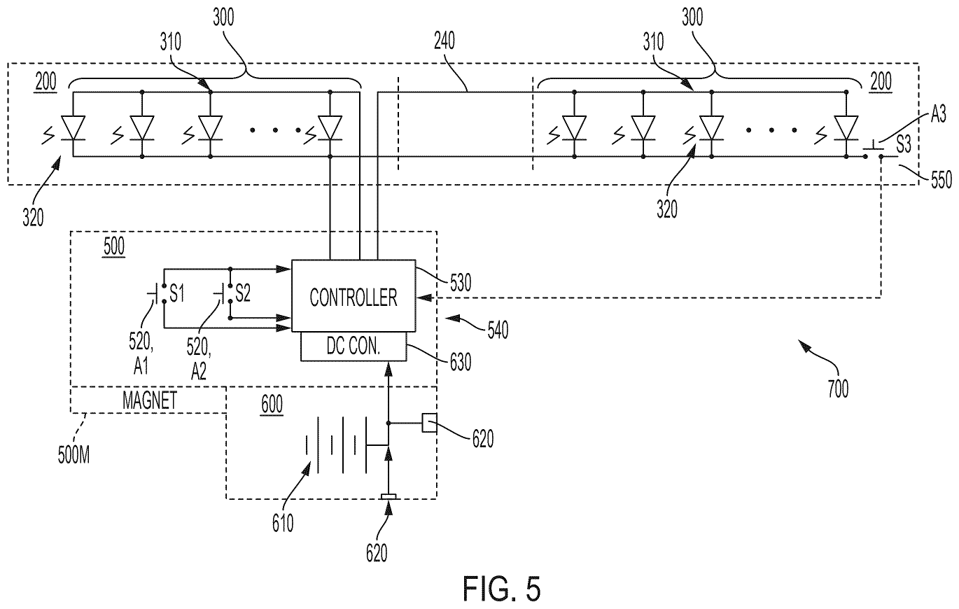

Further, to minimize the number of electrical conductors of light 100 that provide electrical connections between light sources 300, user interface 500 and electrical power source 600, each light source 300 may include a LED controller 340 that is disposed on the same substrate as the LEDs thereof so that controllers of light sources 300 and user interface 500 can signal each other via an electrical conductor serving as a command bus that communicates digital signals representative of the ON and OFF signals for light sources 300 and/or signals representing various operating modes into which light sources 300 may be commanded, e.g., in response to a user actuating actuator 520 and/or actuator 550 (as shown in FIG. 5) in various manners. Typically, various different commands may be communicated via a single actuator and the electrical switch or switches associated therewith, e.g., by the length and/or number of actuations of the actuator, as is known in the art.

Alternatively, light source 300 may be associated with a user interface 500 and/or an electrical power source 600 so as to provide a fully functional light apart from housing 200. Where housing 200 includes a steel strip 220S, 222S, 224S, a magnet 500M may be associated with user interface 500 and/or power source 600 to facilitate removably attaching light source 300 to such steel strip. This arrangement is advantageous because the detachable functioning light source 300 is usable to provide illumination remotely from housing 200 and/or for being recharged independently from housing 200, whereby discharged light sources can be removed for charging and replaced by a fully charged light source. As a result, the running time of a light 100 can be extended almost indefinitely as charged light sources replace discharged ones.

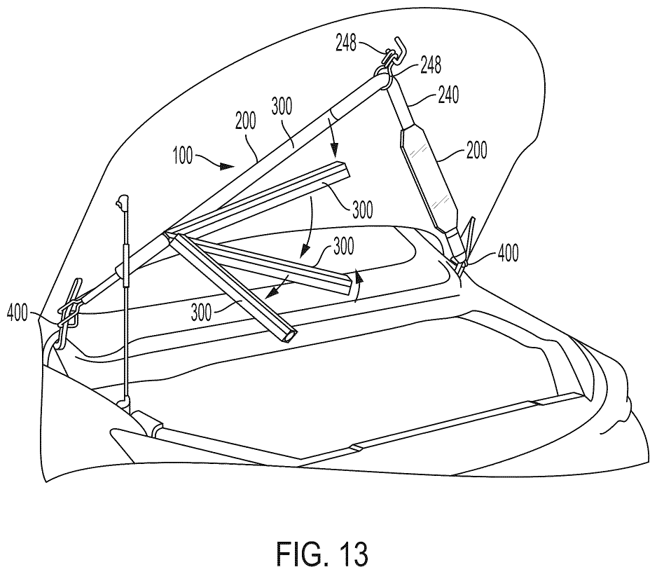

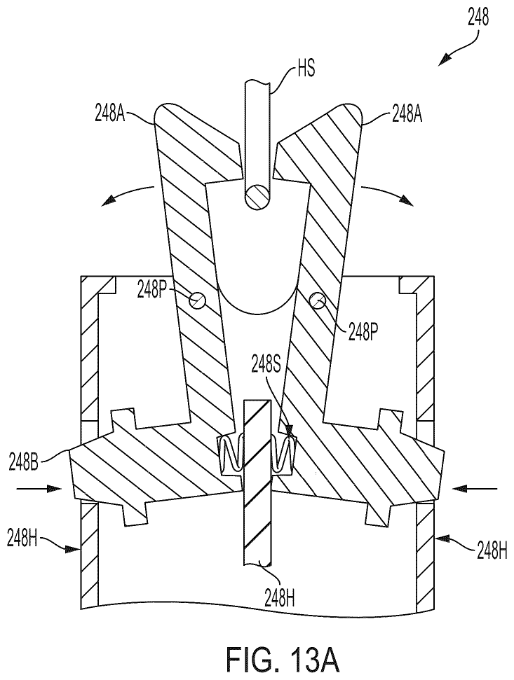

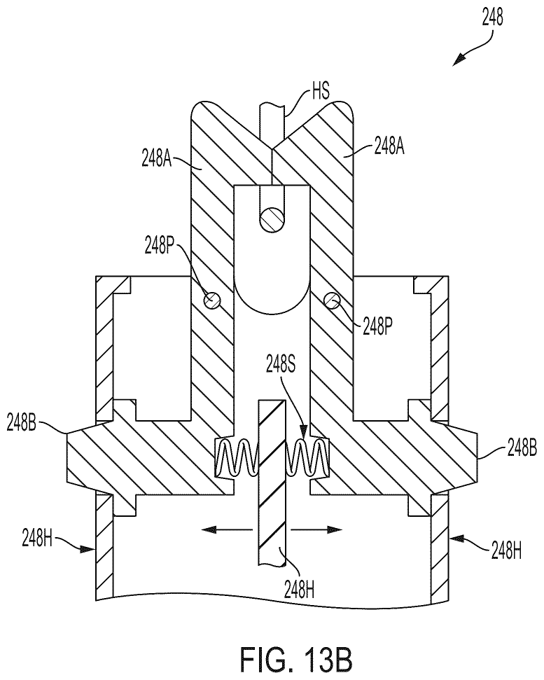

FIGS. 4A and 4B illustrate a deployable light source 300 attached to housing 200. In this embodiment, housing 200 is representative for any of housing members 200, 220, 222, 224, 260 which support this embodiment of light source 300. Deployable light source 300 is movably attached to housing 200, e.g., by a pivotable joint 305, e.g., a ball and socket joint 305 providing positioning of light source 300 over a wide range of angles and directions. Deployable light source 300 is not only pivotable away from housing 200, it is also rotatable over at least 360°as indicated by the arrows in FIG. 4B. Further, FIG. 13 illustrates examples of positions into which this deployable light source 300 may be placed.

Housing 200 has a recess 202 into which deployable light source 300 maybe moved for storage and/or transport, as well as being suitable for use while therein. Recess 202 may extend beyond a size needed to receive light source 300 to provide a touch groove 202G into which a user may place a finger or tool to deploy light source 300. Touch groove 200G may be at an end of recess 202 that is remote from joint 305 and/or may surround all of part of light source 300 when it is stowed in recess 200.

Deployable light source 300 is elongated and includes an elongated array, e.g., of LEDs 320 for producing a desired beam of light, typically a flood beam, and may include an LED 320E on its distal end. Light source 300 may include a user interface 500 and/or electrical power source 600 or may be controlled and receive power from a user interface 500 and/or electrical power source 600 included elsewhere on the light 100 that includes housing 200.

While illustrated as being near an end of housing 200, e.g., near hook 400 and connector 410, one or more deployable light sources 300 may be provided on any one or more of members 200, 220, 222, 224, 260, as may be deemed desirable.

FIG. 5 is a schematic diagram of an example electrical circuit 700 including a user interface 500 and an electrical power source 600 suitable for use in the example light 100. Housings 200 may support one or more light sources 300 which include plural light emitting devices 320 on substrates 310. The plural light emitting devices 320 of each light source 300 may be connected in parallel and to user interface 500. Actuator 520 includes one or more actuators, e.g., pushbuttons A1 A2, which actuate electrical switches S1 and S2. Auxiliary actuator 550 includes electrical switch S3 which is actuated by an actuator, e.g., a pushbutton A3.

User interface 500 includes a controller 530 that responds to actuators 520 and 550 for applying power from electrical power source 600 to energize and de-energize light sources 300 and the various light emitting devices 320 thereof, and to select programmable modes therefor.

Lighting “modes” available with this light 100 via controller 530 include, e.g., turning the light source ON and OFF and selecting one or more operating modes for the light source, wherein the operating modes include: changing brightness, dimming, un-dimming, selecting ones of devices producing light of different colors, selecting ones of devices producing UV or IR light, selecting ones of devices producing light, a flashing mode, a strobing mode, a safety mode, or a combination thereof, or selecting certain LED and lens elements for providing an overall “spot” or “flood” beam mode. In a simpler embodiment, light from LEDs 320 can be controlled by the microprocessor to provide different illumination levels, like “high,” “medium” and “low,” or other combinations as provided and controlled by its programming.

In the illustrated embodiment, electrical power source 600 includes, e.g., one or more batteries 610, which may be and preferably are rechargeable. For recharging, a charging interface 620 may be provided for receiving charging power from an external source. Interface 620 may include an electrical connector, e.g., a USB, mini-USB, micro-USB, USB-C, Firewire or Lightning connector, a coaxial connector, or any other suitable means for transferring electrical energy. Alternatively or additionally, a charging interface 620 may be provided that has a raised triangular member having two electrical contacts as is compatible with an available charging device, e.g., a charger for a STINGER® light or a STRION® light which have receptacles for receiving such triangular charger interface. An example thereof is described in U.S. Pat. No. 5,432,689 entitled “Flashlight and Charging System Therefor” of Streamlight, Inc.

The electrical power source 600, 610 may include, e.g., a lithium battery; or a rechargeable lithium battery; or a lithium battery having a USB connector for receiving charging power; or an electrical connector for connecting to an external source of electrical power; or a combination thereof. User interface housing 510 that provides the compartment into which electrical power source 600 is placed maybe configured for receiving batteries of different types and kinds, e.g., size AA or CR-123 size batteries, as well as of different chemistries, e.g., alkaline or lithium batteries. This feature is referred as being “dual fuel.”

In addition, electrical power source 600 may include a DC converter 630 to increase and/or decrease the voltage provided by a battery 610 or other electrical power source 600 to a desired voltage for operating light 100. An electrical power source may also include an external source of electrical energy, such as an external battery pack or an external adapter/transformer for receiving electrical energy from a typical 120 volt AC power outlet.

Light provided by LED light sources 300 can also be provided to operate in a “safety” mode, wherein the LEDs 320 would receive variable frequency pulse-width modulated (PWM) drive signals that strobe the LED light at a frequency above that perceived by a human eye. As a result, the LED light includes a frequency does not exactly match the frequency of a moving part of the engine and so such part, which may not easily be seen as being moving, is strobed to be clearly visible and so it is believed less likely that a user will place his hand into a space where it could be injured by a moving part of the engine. An example of such safety feature is described by U.S. Pat. No. 11,212,892, entitled “Variable Frequency PWM Led Control and Method” of Streamlight, Inc. which is hereby incorporated herein in its entirety by reference.

Examples of other various types, kinds and configurations of lights having or suitable for being configured with a magnetic mounting arrangement for being attached to work light 100 include, e.g., a “Portable Light Having a Rotatable Cylindrical Head,” U.S. Pat. No. 8,511,847, wherein a magnet configured to attach to light 100 is provided thereon, a “Portable Light with Hanger, Clip and Led Module,” U.S. Pat. No. 8,905,573, known as the POLYTAC® 90 light, wherein a magnet configured to attach to light 100 is provided on the clip thereof, a “Portable Light and Work Light Adapter Therefor,” U.S. Pat. No. 8,870,408, known as the STINGER® work light, wherein a magnet configured to attach to light 100 is provided thereon, a Portable Light Having a Rotatable Head, U.S. Pat. No. 8,777,446, known as the KNUCKLEHEAD® light, which includes a mounting magnet, a “Rechargeable Clip-On Light with Male USB Connector,” U.S. Pat. No. 9,206,951, known as a ClipMate® USB light, wherein a magnet configured to attach to light 100 is provided on the clip or body thereof, and “Head Mountable Lights” as in U.S. Patents D-729,426 and D-733,951, wherein the mounting strap bracket is replaced by a magnet configured to attach to light 100, wherein each of the foregoing patents is assigned to Streamlight, Inc., of Eagleville, Pennsylvania, USA.

Work lights 100 may have adjustable shading, so as to avoid glare. Example work light 100 may also include an adjustable shade that can be moved to cover the length of the light source 300 or a part thereof and thus provide some relief from light glare when light from the light source 300 thereof shines directly or indirectly in the user's eyes.

Because under-hood work lights 100 may rely primarily on flood lighting elements 320 arrayed along the length of the light housing 220, they often are configured to cast the maximum amount of light outwards from light 100, e.g., most often generally downwards, without much concern for focusing or concentrating illumination onto a particular area. As a consequence, however, when the work light 100 is mounted on the vehicle hood and turned on, a significant portion of its light output may be traveling in a direction wherein light from the light's LED elements 300 is directed towards the user's eyes, which is perceived as glare. This kind of glare is uncomfortable for most people and actually diminishes the benefits of having an under-hood light, as glare traveling directly from the light to the user's eyes often interferes with the user's being able to clearly see what is in the engine compartment, i.e. the object of his work efforts.

Accordingly, this example embodiment of work light 100 may further include a pivotally mounted shade that extends along the length of the light, e.g., along the length of housing members 220 or at least the part thereof that includes a light source 300. The shade need only be a few inches in width and is manually positionable by the user to block stray light coming from the LED elements directly into the user's eyes, in effect creating a shadow in the light right at the appropriate place to shield the user's eyes and thereby maximize the relative amount of light that the user can see reflected from objects in the engine compartment, from the objective of the user's work. Alternatively, an articulated and/or pivotable light source 300 as described above may provide such shading using directed light.

The example embodiment may also include a magnetic surface, e.g., a magnet, where small metal tools and/or parts, e.g., nuts and bolts, can be attached and stored temporarily while a person is working, e.g., in an engine compartment. A steel strip, e.g., magnetic steel strip 220S, may provide such surface.

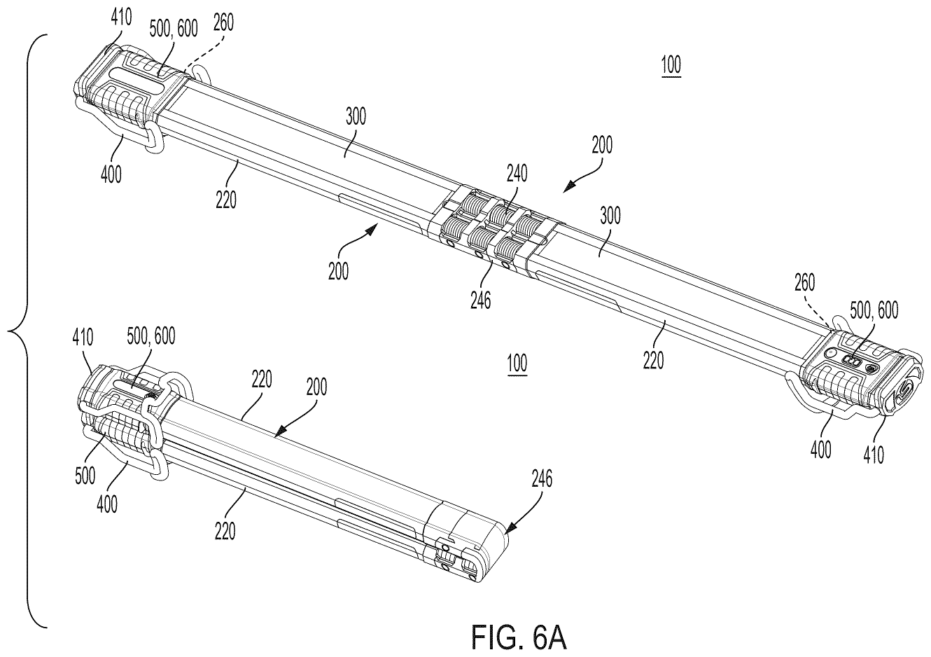

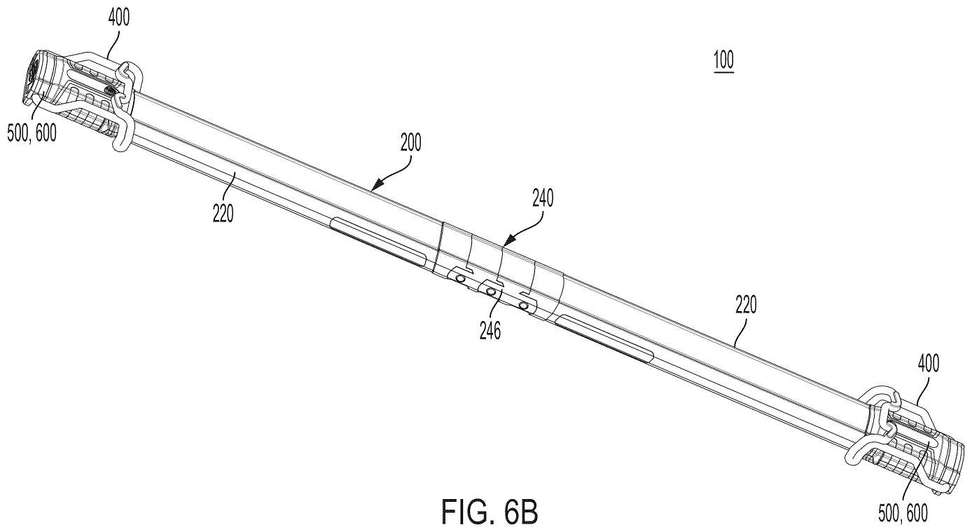

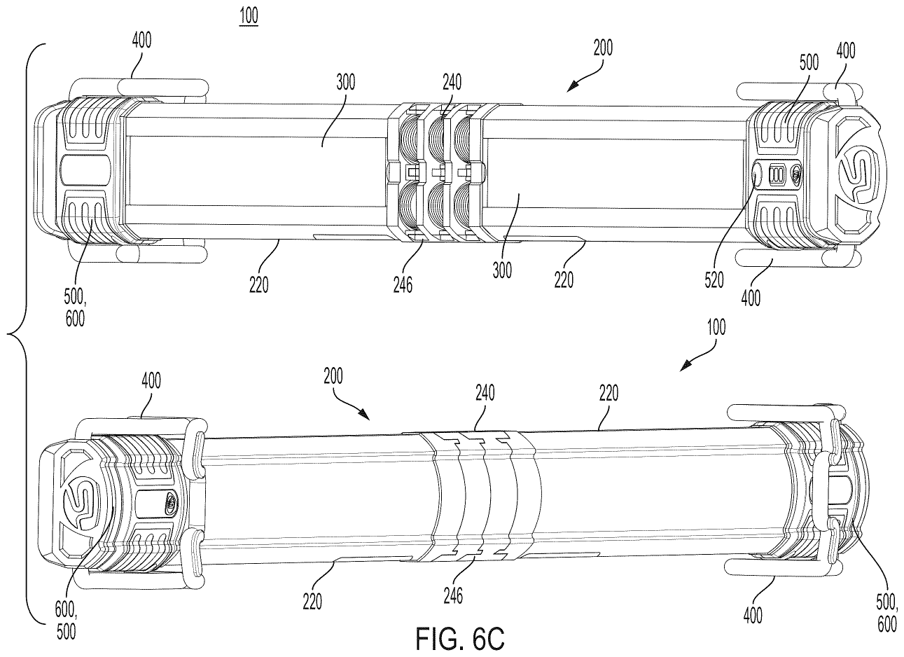

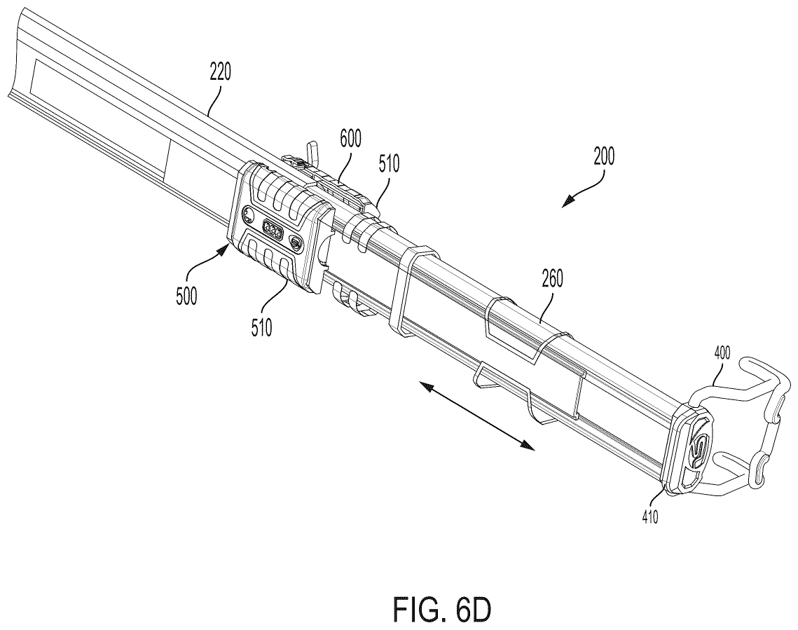

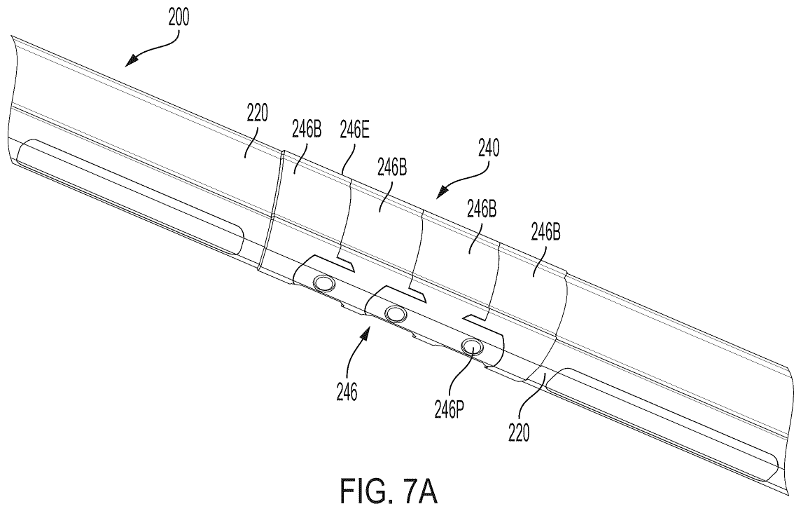

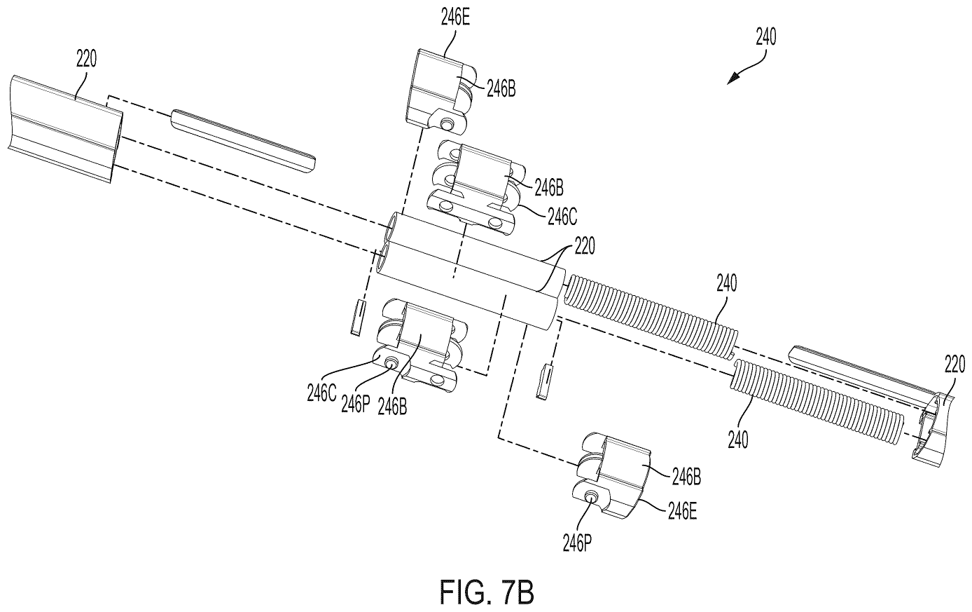

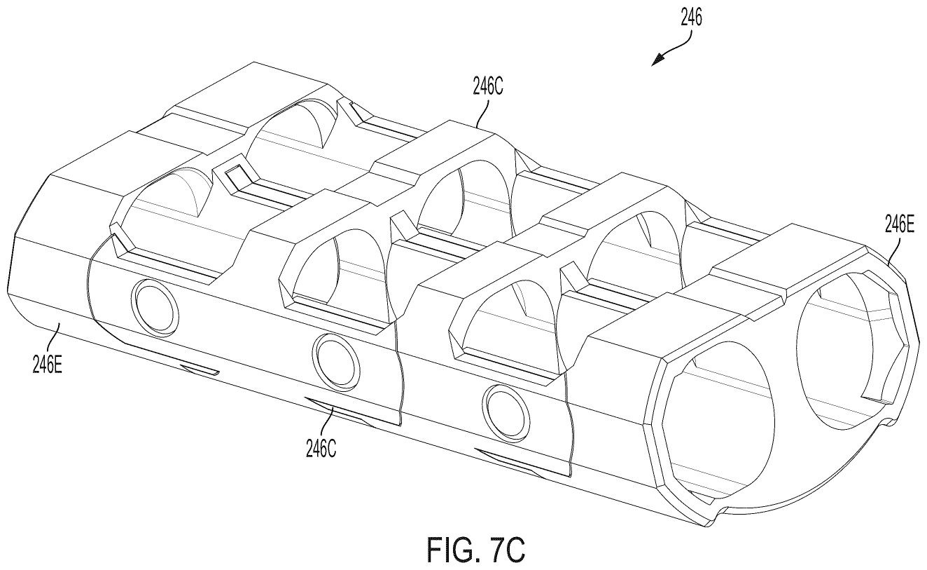

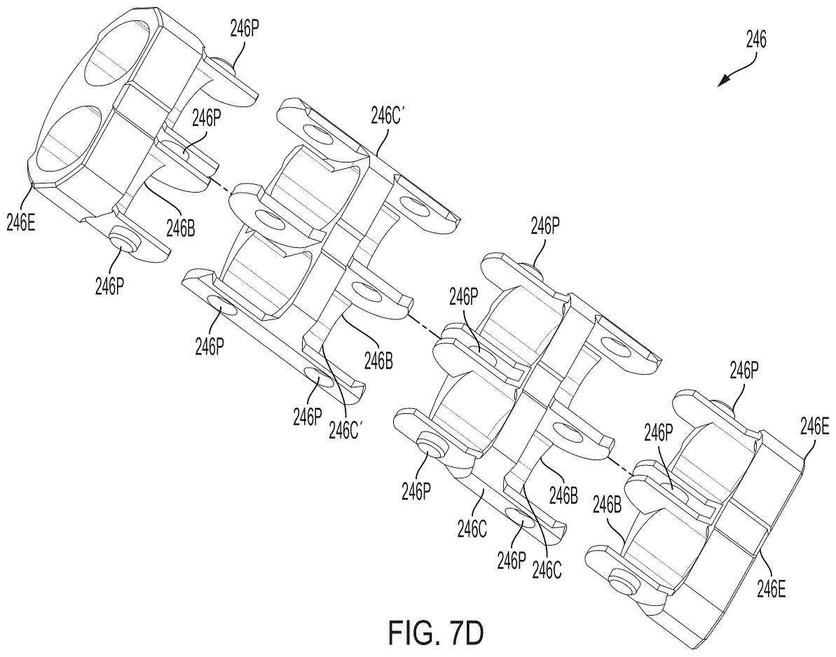

FIGS. 6A through 6D illustrate a further example embodiment of a work light 100 having an exoskeleton spring joint 240 and other advantageous features, and FIGS. 7A through 7D illustrate examples of example molded and linked “drag chain” exoskeleton members 246 for a spring joint 240. Therein, FIGS. 7B and 7D further illustrate details of elements of an example embodiment of a molded drag chain exoskeleton member 246.

One potential issue with a one-spring joint 240 of the example work light 100 is that, when the light is in its unfolded configuration and mounted to, e.g., a very wide vehicle hood, a particular spring 240 may not provide enough support to the two light bars 220 to avoid sagging at the middle of the work light. Of course the sagging does not interfere with the basic functioning of the work light, but it may detract from the overall attractiveness of the work light. Sagging suggests poor quality and visually appears sloppy; as a functional matter, sagging can change the direction in which the light is projected.

To avoid this issue, the spring joint 240 may be encircled by an exoskeleton member 246 to stiffen the spring joint 240 in a direction to avoid or reduce sagging. Examples of exoskeleton members 246 include a molded “drag chain,” e.g., a set of two or more molded “drag chain” links 246C, 246E, linked together as illustrated.

A drag chain or exoskeleton 246 protective covering may comprise a series of connected links that secures, e.g., cables and hoses and in this example, one or more springs, to keep them separated and to permit movement, e.g., around automated machinery, here in an engine compartment or other work environment.

In some examples, drag chain links may have the following characteristics—(1) two rigid, parallel, vertical side plates on either side of the link that are pivotally connected to the vertical side plates of the next link in the series, (2) horizontal bottom and/or top members that are arranged parallel to each other and perpendicular to the side plates such that the bottom, top and side plates define an open path through the body of the drag link, and (3) stop-motion blocks, bosses, pins or surfaces on each link that are arranged to prevent each link from pivoting with respect to the next link in the series except for pivot angles within a defined range of motion.

In this example, the drag chain links would be arranged so that the work light spring joint 240 would be enclosed within the cavity of the drag chain and the links oriented so that the drag chain links would pivot freely to allow the two housings 220 of the light 100 to be folded for storage but would not allow any pivoting past the substantially flat, 180° orientation. With these drag chain links providing extra support to the spring joint 240, the light 100 tends to remain flat and rigid when unfolded and mounted in use, e.g., on the hood or trunk lid of a vehicle.

Work light 100 comprises a housing 200 including plural outer housing members 220 connected by a spring joint 240 including two side-by-side springs 240 within an exoskeleton member 246. Each housing member 220 has one or more light sources 300 thereon, e.g., an elongated LED light source 300, and an end assembly including a user interface 500 and/or an electrical power source 600 at one end or at both ends of light 100. A deployable and stowable hook 400 is provided on a connector 410 at each end of light 100.

Preferably, one or both housing members 220 include an inner extension member 260 that telescopes into housing member 220 and is biased for retraction into housing member 220. This arrangement facilitates housing 200 being stretched (elongated) such that light 100 is able to span a larger distance, e.g., for grasping opposite edges of a vehicle hood or other object, while maintaining a shorter dimension for storage and transport.

For example, as shown in FIG. 6D, light 100 housing 200 includes one or more inner extension members 260 that are slidable relative to outer housing members 220 as indicated by the double ended arrow. Inner extension member 260 is biased to be pulled into outer housing member 200 by a biasing member 270 therein (as indicated by a dashed lead line in FIG. 6A) and is manually pulled out of housing member 220 for extending the length of work light 100 for hooking it onto an object, e.g., a vehicle hood, wherein the biasing member 270 then biases hooks 400 inwardly to grasp the object, e.g., the edges of the vehicle hood. A hook 400 is provided at the respective distal ends of extension members 260 and is attached thereto by a connector 410 by which it is pivotable and/or rotatable, as shown in FIG. 6D.

Example spring joints 240 may include plural springs or springs with non-circular cross sections. In these example embodiments, the spring joint 240 located between the two halves housing members 220 of the light body 200 is a double spring, with each spring having a single, circular cross-sectional profile.

An issue with a single, circular-profile spring is that it allows the two halves of the light body to be flexed with equal force in multiple directions. In other words, the light can be folded in the correct position for storage, but the spring also permits the light to be folded in the opposite direction, which might not permit the latch mechanism to work or might otherwise damage the light's internal wiring. A single circular spring may also allow the light to sag or bend in undesired directions.

So instead of using a single spring 240 with a circular profile or cross section, a spring or plural springs 240 with a non-circular profile, such as an oval, elliptical, or a rounded square or rectangular profile, or two or more springs with circular profile that are placed side-by-side, may be employed. With this configuration, the spring joint can be flexed easily in the correct direction, so that the light bars fold into the storage configuration, but is resistant to bending in other directions. The non-circular cross-sectional shape of the spring (or the locations of plural springs) tends to prevent the light housings from being flexed or folded in an incorrect or undesired direction.

Example spring joint 240 includes two springs 240 in side-by-side configuration in an orientation for enabling outer housings 220 to be folded against each other for transport and storage, in a preferential direction. In one preferential direction, light sources 300 are on the outside for providing illumination when the light 100 is folded and wherein end assemblies 500 and hooks 400 are disposed for providing “feet” for light 100 facilitating its being used as a standing light. In another preferential direction, the light 100 is folded so that the light sources 300 are adjacent and facing each other, thereby being somewhat protected in the folded configuration and/or hooks 400 are disposed for engaging a part of light 100 for retaining light 100 in the folded configuration.

As further illustrated in the exploded views of FIGS. 7B and 7D, for example, spring joint 240 or hinge 240 of work light 100 includes two side-by-side coiled springs 240 that are attached at their ends to housing member(s) 220 and are enclosed within an exoskeleton 246. Exoskeleton 246 includes an end member 246E at each end that are connected via one or more center members 246C, e.g., here two center members 246C, that are pivotably interconnected to each other by respective complementary pivot elements 246P, e.g., projections and openings 246P.

Each member 246C, 246E has a back 246B that is configured to cooperate with the others by interfering with the back(s) 246B of the adjacent member(s) 246C, 246E. Such interference tends to limit springs 240 from bending beyond housings 200, 220 being substantially straight, e.g., from an about 180°flat position. As a result, light 100 may be folded at spring connector 240 in one predetermined direction into a compact configuration, e.g., for storage and transport, and may be unfolded into a 180° flat, deployed position, but may not be folded in the opposite direction.

User interface 500 includes a housing attached to the distal end of housing member 220 for supporting, e.g., electronic circuitry for operating work light 100 and the light sources 300 thereof as described herein. An electrical power source 600 as described herein is provided at one end or at both ends of light 100 and may be disposed in the housing 510 of user interface 500. User interface 500 may include one or more indicator lights for indicating the state of light 100, e.g., the relative state of charge of electrical power source 600 or another operating parameter.

Also for example, the two-part housing 510 for user interface 500 may include in one part thereof user interface 500 and may also include in the other part thereof electrical power source 600. The two parts of user interface housing 510 may be pulled together around and against housing member 200, e.g., by one or more fasteners, to be attached thereto.

Any one or more of the housings in the foregoing embodiment of light 100 may employ the housing configuration of housings 200, 220, 222, 224 that have a steel strip along a side thereof for facilitating magnetically attaching light sources 300 and other accessories thereon as described above.

Regarding the present example embodiment of a drag chain exoskeleton member 246 illustrated in FIGS. 7A-7D, molded exoskeleton member 246 comprises a pair of end links 246E and one or more center links 246C that pivotably interconnect thereto at their respective outer rails. Each link 246C, 246E has one or more openings (the number of which corresponds to the number of springs 240 of spring joint 240) that align with adjacent links to define a longitudinal passage along the length of exoskeleton member 246 through which a spring 240 can be disposed.

In addition to molding, drag chain links and members may be made by casting, machining, milling, welding, brazing, assembling with fasteners, or any other known method of making such items, or by any combination thereof, and may be formed of any suitable plastic, resin or metal material.

Each link 246C, 246E also has two or more substantially parallel side rails that each have a pivot element 246P, e.g., either a circular hole or a circular nub 246P, that engages the complementary pivot elements 246P of the adjacent center or end link 246C, 246E, whereby the connected links 246C, 246E when joined together by the pivot elements 246P of their respective side rails are pivotable about an axis that extends across exoskeleton member 246 and transverse to the longitudinal axis of spring joint 240.

Each link 246C, 246E also has a stop or base 246B on one side thereof that joins together their respective substantially parallel side rails and is configured to come into contact with, i.e. interfere with, the base 246B of adjacent links 246C, 246E. When the exoskeleton member 246 is moved to bend in an undesired direction, or beyond its predetermined angular range, the adjacent bases 246B come into contact (interfere) to limit the bending of pivot elements 246P past the, e.g., substantially flat, 180° orientation. thereby to reduce and/or prevent the aforementioned sagging issue.

In the illustrated arrangement, example end links 246E have circular nubs on both side rails and center links 246C have a projection, e.g., a circular nub, and an opening, e.g., a circular hole, on each side rail. In the illustrated embodiment, plural center links 246C may be employed while a one of links 246C that is adjacent to one of the end links 246E is longer so that its pivot elements 246P can engage with the complementary pivot elements 246P of an adjacent end link 246E and an adjacent center link 246C adjacent thereto.

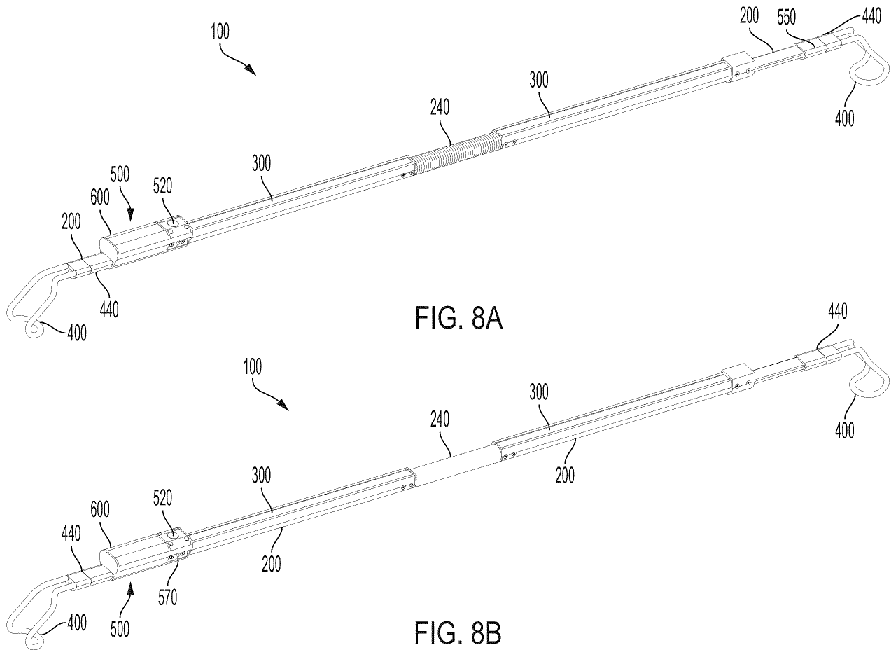

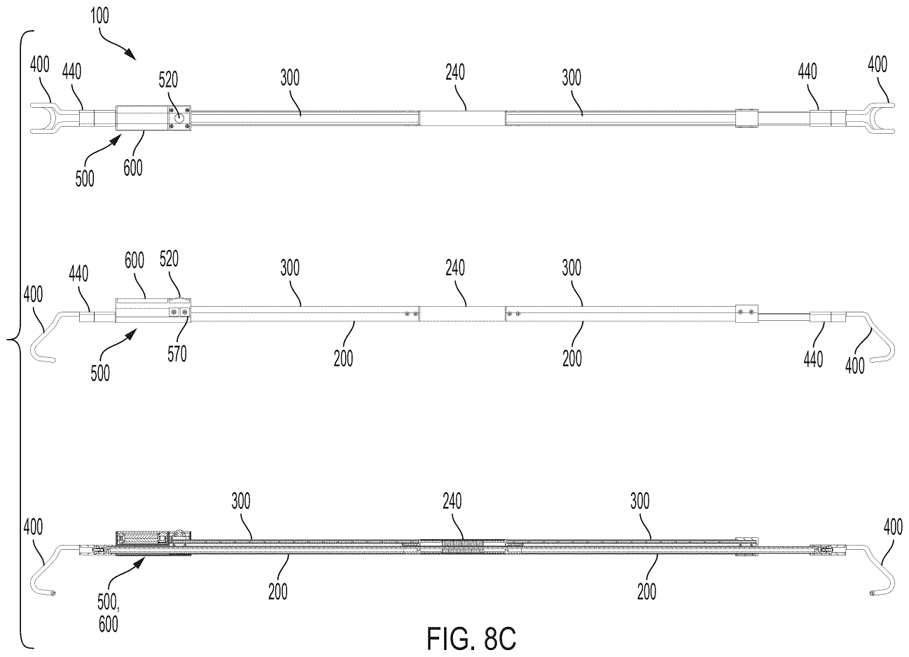

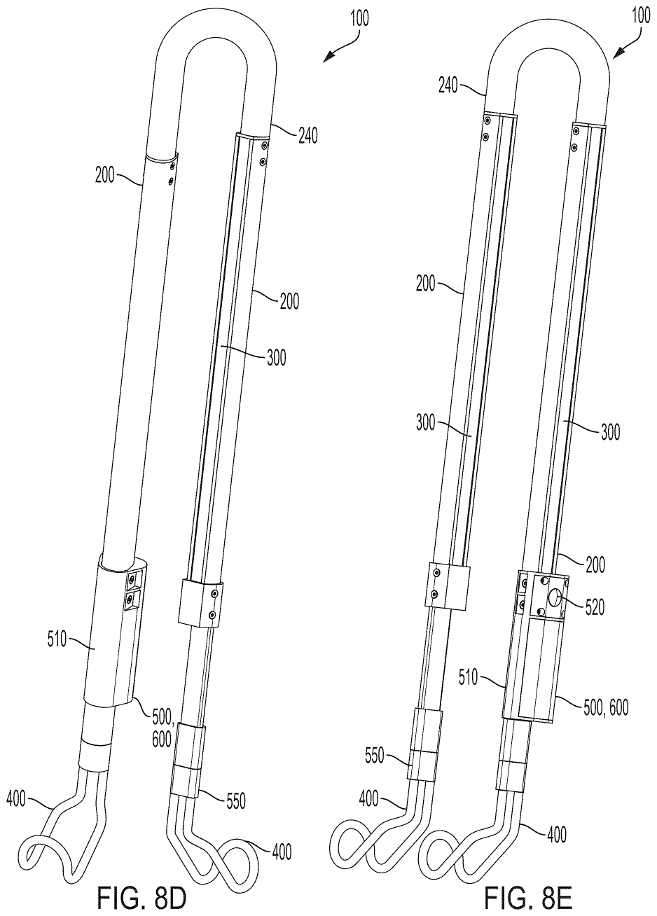

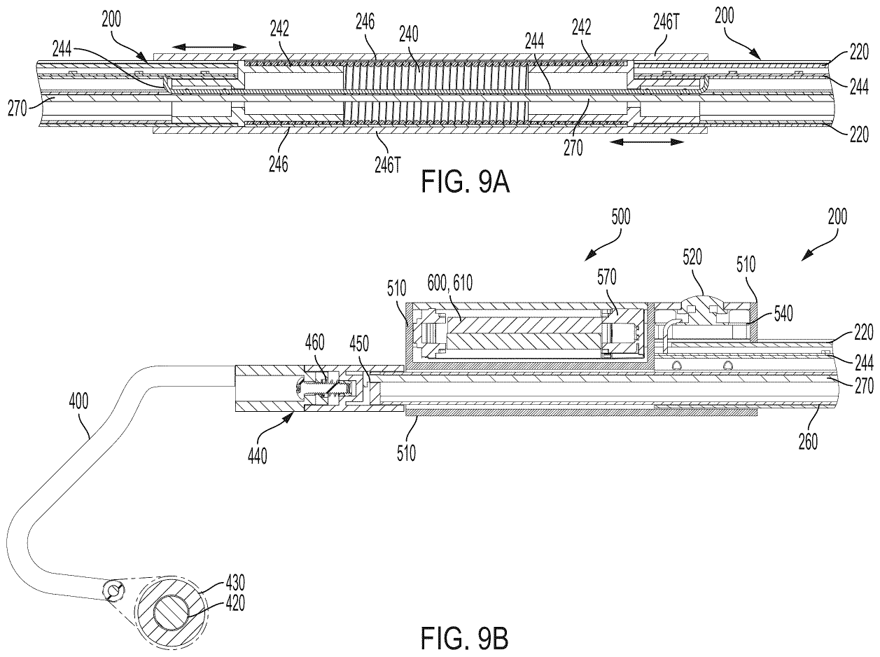

FIGS. 8A and 8B are each perspective views of an example embodiment of a work light 100 according to the present arrangement in a deployed configuration as for being used and in a collapsed configuration, FIG. 8C illustrates FIG. 8C illustrates two side views and a sectional view of the example light 100 of FIGS. 8A-8B; and FIGS. 8D and 8E are perspective views of the example light 100 in a non-deployed folded configuration for storage or transport; and FIGS. 9A and 9B are cross-sectional views thereof at two different locations along its length illustrating the arrangement of a coil spring joint 240 thereof and of an example user interface 500 thereon, respectively;

Work light 100 comprises a two housings 200 that are flexibly joined together by a central spring joint 240 or spring connector 240 employing a coil spring. Each housing 200 has a hook 400 at its end distal from the central spring connector 200 for engaging an object, e.g., a vehicle hood, to which light 100 is attached for providing light on a work space. Work light 100 may also be referred to as an under-hood light 100 because it is suitable for use in an automotive environment.

Preferred features of the work light 100 arrangement described herein include inter alia a slim profile and size. Housings 200 may each include a lightweight outer housing member 220, e.g., a tube or an extruded aluminum channel, and an inner extension member 260 that telescopes into outer housing member 220. An extendable hook 400 is provided at each of the distal ends of housings 200 at both ends of light 100. Preferably, hooks 400 are padded hooks 400 to protect, e.g., the vehicle hood.

Alternatively, housings 200 may each include a lightweight outer housing member 220 and a lightweight inner extension member 260 each including an extruded aluminum channel having a track in which is disposed an elongated steel strip as previously described, for magnetic attachment of various light sources 300 as previously described.

Preferred features also include an integrated rechargeable battery, a unique central spring joint 240 connecting the two housings 200 and providing full 180 degree bending for compact transport and storage, a compact size when collapsed whereby work light 100 can fit in a toolbox or in a drawer of a shop chest. The central spring joint or connector 240 provides advantages over presently available traditional hinges including improved durability and ruggedness, fewer parts and simpler assembly. Because coil spring 240 can bend in any direction, e.g., 360 degrees radially, it is both rugged and cannot be damaged by being bent in a “wrong” direction. In addition, the preferred coil spring 240 provides a bias that will tend to move housings apart from their storage positions into a generally straight alignment for use.

Housing 200 and hooks 400 are arranged so that they can be placed over the opposing edges of a raised vehicle hood so that the light source 300 thereof illuminates the entire working area of an engine that requires some service or repair. In addition, the example light 100 can also be used in locations other than under a vehicle hood including, but not limited to attaching to the underside of a vehicle, a vehicle trunk lid, another door of a vehicle, spanning the inner portion of a vehicle, e.g., by engaging hooks 400 with the front seats or back seats thereof or vehicle by opening opposite doors and engaging hooks 400 with the door jambs. Further, light 100 can be hung vertically or at any angle on a wall, pipe, or other structure whether adjacent to a vehicle or not, or light 100 can stand in a folded (storage) position on a horizontal surface to illuminate an area or the side of a vehicle.

Preferably, light 100 is adjustable in length so that it can grasp a wide range of hood sizes and configurations, and other objects. The adjustable length of light 100 is preferably provided by the housings 200 including a biasing member 270 that pulls each hook 400 towards the other hook, i.e. pulls both hooks inward towards coil spring 240. Biasing member 270 may be, e.g., a long coil spring or a bungee cord or another elastic member. The biasing member 270 is typically internal to light 100, e.g., internally to housings 200 and coil spring 240, where it is protected from physical damage and contamination.

To attach light 100 to a vehicle hood or other part, the user pulls hooks 400 apart against the force of the spring biasing member 270 to spread the hooks 400 to fit around the edges of a raised vehicle hood or other object. Then releasing the hooks 400 or relaxing the tension thereon will move hooks 400 toward the edges of the raised hood or other object and to remain in position thereon due to the tension provided by the spring biasing member and friction between hood edges and the hooks 400.

Any one or more of the housings in the foregoing embodiment of light 100 may employ the housing configuration of housings 200, 220, 222, 224 that have a steel strip along a side thereof for facilitating magnetically attaching light sources 300 and other accessories thereon as described above. light 100 shown in FIG. 9A, coil spring 240 is fastened to and retained 242 on respective ends of the two housings 200 to provide a flexible connector or joint 240 therebetween. A fastener 242 retains coil spring 240 on the ends of housings 200. The illustrated example of a fastener includes, e.g., an adapter 242 that is configured to tightly engage the ends of coil spring 240 and outer housing member 220, and that may include a screw or another fastener for retaining housing 220 and/or substrate 300 of light source 300 thereto. Coil spring 240 is biased to orient housings 200 in substantially a straight configuration while providing sufficient flexibility that the housings can be moved to be side-by-side for compact storage and transport.

The coil spring 240 may be slidably fastened to the respective first ends of the housings 200 and/or may be enclosed within the respective first ends of the housings 200 when the respective first ends of the housings are attached to each other. whereby light 100 resists sagging when the light 100 spans a relatively long distance.

Tensioning or biasing member 270 which is fastened to respective inner extension members 260 of the two housings 200 passes through the center of coil spring 240. Tensioning member 270 may be of any sort of suitable biasing device, e.g., a long coil spring 270 or a bungee cord 270. In the illustrated example embodiment, biasing member 270 extends from the distal ends of housings 200 so as to have a longer length, thereby to reduce the ratio of its longest length in tension (when light 100 is extended to ita maximum length) to its shortest length (when light 100 is at its shortest length and biasing member 270 is most relaxed).

Also passing through coil spring 240 may be electrical conductors 244 for connecting the light source 300 of one housing 200 to the user interface 500 when the user interface 500 is mounted to the other housing 200 and to the electrical power source 600, as well as providing connections of various actuators and electrical switches as described below. Electrical conductors 244 may include insulated wires or may include one or more electrical circuit boards 244. The circuit boards 244 may be rigid or flexible circuit boards 244, and conductors 234 may include a combination of wires and/or similar or different circuit boards.

Coil spring 240 of the center joint provides a distinct improvement over the current state of the art lights. Coil spring 240 provides simplicity combined with durability-the spring joint is capable of lasting for a long lifetime of reliable service without any degradation or appreciable wear. It can be covered repeatedly with grease, water, oil or dirt and then cleaned many times without any damage, if it is left exposed. It can be dropped, stepped on or abused in multiple ways without harming it. It requires no instructions or special care to operate, and it cannot be bent or flexed in any “wrong” direction. The coil spring 240, which is typically relatively centrally located along the length of light 100, provides simplicity with both ruggedness and durability, which are key to a long and reliable service life. The coil spring 240 is also inexpensive and quick to assemble, which provides for more cost-effective manufacturing of the light 100 compared to other, more costly mechanical hinge systems.

The centrally located spring connector or joint 240 is particularly useful when it is biased to compress itself into a straight configuration, which is preferred. As a result, coil spring 240 when in light 100 is biased towards unfolding the connection 240 into a straight configuration, which is the configuration in which light 100 is most commonly operated. From the storage configuration, the device user can simply separate the two hooked ends 400 from each other, and the spring connector 240 “snaps” the housings 200 into the straight alignment configuration for using light 100. Coil spring connector 240 also imparts a small amount of extra “stretch” to the overall length of light 100, which might be helpful in extending the hooks 400 over a particularly wide object.

Optionally, a sheath 246 may enclose coil spring 240 to prevent the entry of dirt and liquids into light 100, e.g., into housings 200 thereof. Sheath 246 is preferably of a flexible material that is impervious to water, oils, lubricants, solvents and the like that are commonly used in an automotive environment. Alternatively, a seal may be provided in the ends of housings 200 at coil spring 240 to reduce entry of undesirable materials into those housings.

Optionally, sheath 246 may be a rigid tube 246T having a cross-section of like shape and of a slightly greater dimension than that of housing members 200 so that it can slide along members 200 (as indicated by the double-ended arrows)to enclose coil spring 240, thereby to add rigidity to housing members 200 in the deployed configuration and to resist dirt and moisture entering housings 200, and may be slid away from joint 240 onto a housing 200 to allow light 100 to be folded for storage or transport.

Similarly, one of housing members 200 may be of a slightly larger size and the end of spring 120 disposed therein may be slidable into and out of that housing member 200, wherein in the deployed configuration that housing member 200 may slide over spring 240 (i.e. spring 240 slides into that housing member) so as to engage the near end of the other housing member 200 which will add rigidity to light 100 when deployed with its housings members 200 so engaged. In this arrangement, housing 200 and/or spring 240 has a physical feature, e.g., a retainer, that prevents spring 240 from being removed entirely out of housing 200.

Light 100 includes a user interface 500 for receiving commands from a user for controlling the operation of light 100 and in particular, one or both light sources 300 thereof. To that end, user interface 500 includes the electronic circuits for controlling one or both light sources 300 and an actuator 520, e.g., a “button” 520 or other feature to which pressure may be applied and released for actuating and de-actuating an electrical switch of user interface 500 that controls the electronic circuits thereof.

User interface 500 may also include a device 560 for indicating the status of the power source 600, e.g., battery 600, 610, functionality. The device 560 may comprise one or more indicator lights displaying one or more colors and/or operating modes (e.g., single intensity on, blinking on and off, varying intensity, and similar variations) to indicate to the user the charge status of the battery, namely, whether it is fully charged, nearly empty (discharged), receiving charge from an external power source, etc. Indicating device 560 of user interface 500 may also include a small LCD or LED screen 560 providing short messages including alphanumeric characters and/or symbols to indicate the status of the battery, the operating mode of the light and/or instructions for operation thereof. While user interface 500 could be located at any desired location along the length of housings 200, it is typically located near an end of light 100, e.g., proximate a hook 400 thereof, which would be convenient to a user standing near the engine compartment that light 100 illuminates. In addition, and optionally, an auxiliary actuator 550 may be provided near the opposite end of light 100 for the convenience of the user when working in the vicinity of that end of light 100.

Preferably, light 100 will also include a electrical power source 600 so that it does not have or need additional wires or plugs in order to be operated, and so that it can be used roadside and in other locations where there is no access to an external source of electrical power, e.g., an external charger or a wired electrical outlet. While electrical power source 600 could be located anywhere along light 100, electrical power source 600 can be and typically is located adjacent to user interface 500 and may be combined therewith in a common enclosure or housing.

Also preferably, hooks 400 may be covered with padding or a soft compliant material so that they do not chip, scratch or otherwise damage the, e.g., painted surfaces and edges of the hood or other object. Hooks 400 have a rigid hook structure; or have a rigid hook structure covered by a resilient pad or covering to reduce the likelihood that auto part of other object to which light 100 is attached is scratched or otherwise damaged by light 100.

In addition, housings 200 preferably include a telescoping inner extension member 260 that retracts into the hollow center of outer housing member 220 at the hook 400 end of one or both of housings 200. This feature advances simplicity combined with durability, as does coil spring 240. Retraction of inner extension member 260 into outer housing member 220 is effected by a biasing member 270 which may be an elongated coil spring 270 or a simple bungee cord 270 that permits the hooks 400 to be pulled to extend outwardly while still providing an appropriate amount of biasing force against their extension such that the hooks 400 are pulled inwardly to grasp a hood or other vehicle part or object to which a user desires to attach light 100.

Similar to the coil spring 240, the bungee cord material can be covered repeatedly with grease, water, oil, dirt and then cleaned without any damage. It cannot be damaged through any normal use or moderate abuse and requires no special instructions or special care to operate reliably. A bungee cord 270 is also serviceable-if the bungee material were to lose its elasticity at some point, that bungee material can be removed from the center of the housings 200 and replaced with new bungee material. Biasing member 270 may be a single bungee cord 270 or may be plural bungee cords 270, and either of the foregoing bungee cord 270 arrangements may be replaced with the other thereof, e.g., to adjust the amount of force exerted for pulling the inner extension members 260 inwardly into housing 200. Nevertheless, providing seals and/or a sheath 246 can ordinarily be a sound preventive measure against contamination and/or physical damage.

The hooks 400 of light 100 are also preferably rotatable with respect to housings 200 and light sources 300 thereon, e.g., about the longitudinal axis of housings 200, so that when hooks 400 engage the edges of a hood or trunk lid, the housings 200 and the light sources 300 thereon can be rotated to various angles so that the light sources 300 can be oriented to face and provide lighting to the desired areas. Rotation of hooks 400 may be unlimited, that is, through a complete 360 degrees or more of rotation, or may be limited to a smaller value, such as 45, 90 or 180 degrees of rotation.

Further, hooks 400 are also preferably pivotable relative to the longitudinal axes of housings 200, e.g., so that they can be pivoted to facilitate their engaging a vehicle part, e.g., a hood or trunk lid, as well as being pivoted to a desired position for storing light 100 and/or for standing light 100 on its hook end when housings 200 are folded to be side-by-side. The light 100 may also include a strap, clip, lock or some other retaining mechanism for releasably securing the hooks 400 in a bent or folded position and/or a spring or similar mechanism for biasing the hooks 400 in an extended position.

Alternatively, the light 100 may also include a spring or similar mechanism for biasing the hooks 400 in a bent or folded position, so that the hooks 400 must be unfolded against the resistance of the spring or biasing mechanism in order to secure the hooks to the edges of a vehicle's hood. Hooks 400 may be provided with detents to retain them in one or more desired positions. The hooks 400 may be folded and/or rotated to alternative positions for storage of the light 100 when not in use; the folding and/or rotation of the hooks 400 may reduce the total length of the light 100, further facilitating storage of the light. Straps, hooks, clips, locks or some other retaining mechanism may also be incorporated into the light 100 and/or hooks 400 to releasably secure the housing portions 200 of the light in a folded position, facilitating the storage and transport of the light.

In a preferred arrangement, each hook 400 is supported on the end of housing 200 by a hook retainer 440 which includes at least a pivot joint facilitating hook 400 being pivotable relative to housing 200. It is also desirable that hook 400 be rotatable relative to the longitudinal axis of housing 200. To that end, retainer 440 may also include a rotating joint whereby hook 400 is rotatable about the longitudinal axis of housing 200; alternatively, when the part of housing 200 to which hook 400 is connected is itself rotatable relative to housing 200, then retainer 440 need not include a rotatable joint. illustrating an example user interface 500 in a housing 510 thereon and an example telescoping housing 200 including an outer housing 220 and an inner extensible member 260.

User interface 500 includes a user interface housing 510 which includes actuator 520 for controlling the operation of light 100 and light sources 300 thereof. Electronic circuit board 540 includes an electrical switch actuated via actuator 520 and the electronic circuitry that is provided for so controlling light 100 and light sources 300 thereof. In the example embodiment, electrical conductors 244 connect circuit board 540 to light sources 300 and to auxiliary actuator 550 if provided. Electrical conductors 244 may include wires and/or circuit board elements as described above.

Housing 510 also includes in the example embodiment 500 the electrical power source 600, typically one or more batteries 610 which provide electrical power for operating light 100 and powering light sources 300 to emit light of various types and kinds.

Further, where a charging interface 570 is provided, as is preferred, it is also included in housing 510 for charging a rechargeable electrical power source 600. The charging interface may be an electrical connector 570, e.g., a USB, mini-USB, micro-USB, USB-C, Firewire or Lightning connector, or any other suitable means for transferring electrical energy. Batteries 610 to provide electrical power may also be replaceable batteries, such as dry cell or alkaline batteries. Electrical power may also be provided through connection of the light to an external source of electrical power, such as an adapter connected to a standard 120 or 240 volt alternating current electrical outlet.

Hook 400 is connected to housing 200 by retainer 440 which not only retains hook 400 on housing 200, but preferably also enables the pivoting and/or rotating of hook 400 relative to housing 200. Retainer 400 typically includes a biasing member 460, e.g., a spring 460, for returning hook 400 to a non-deployed position for storage or transport and/or a ratchet 460 for retaining hook 400 in a use position relative to housing 200 and/or in positions intermediate a use position and a storage position, and may also provide detents so that hook 400 tends to remain in one or more predetermined positions.

Retainer 440 may also include a biasing member retainer 450 which retains the end of biasing member 270, e.g., bungee 270, at the distal end of housing 200, e.g., of outer housing member 220 for biasing inner extension member 260 (and hooks 400) in tension to be withdrawn into outer housing 220. One embodiment of hook 400 includes an inner structure 420 that is relatively rigid and an outer cover 430 that is preferably resilient or cushioning, e.g., padding, for protecting the vehicle parts or other object to which light 1000 is attached. The inner structure 420 may be a formed metal wire or rod, a molded plastic or another suitable structure.

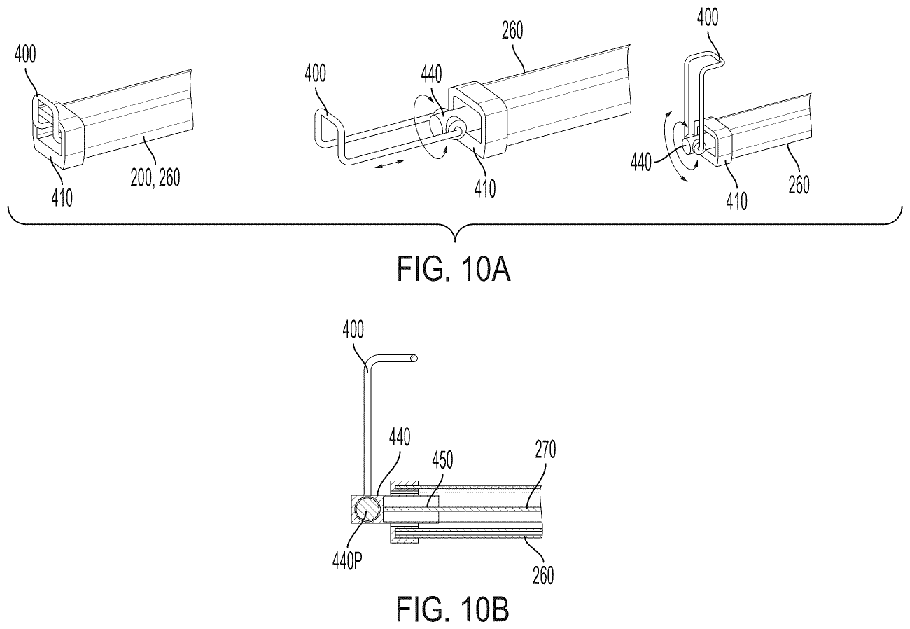

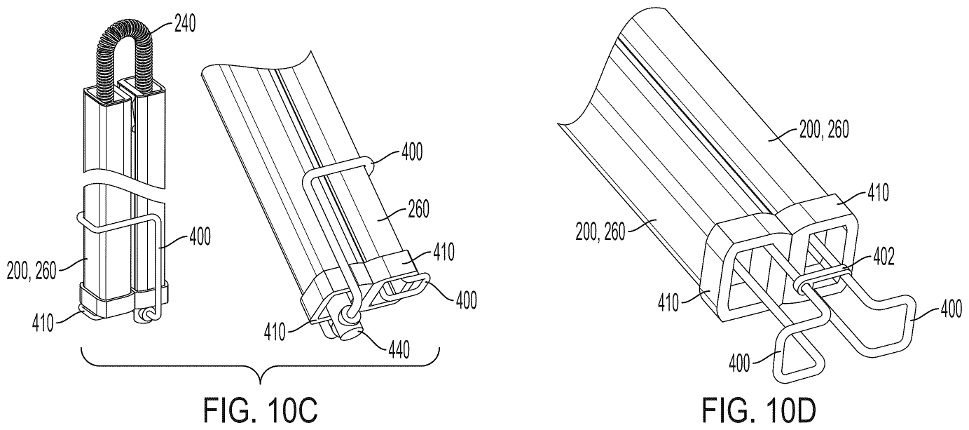

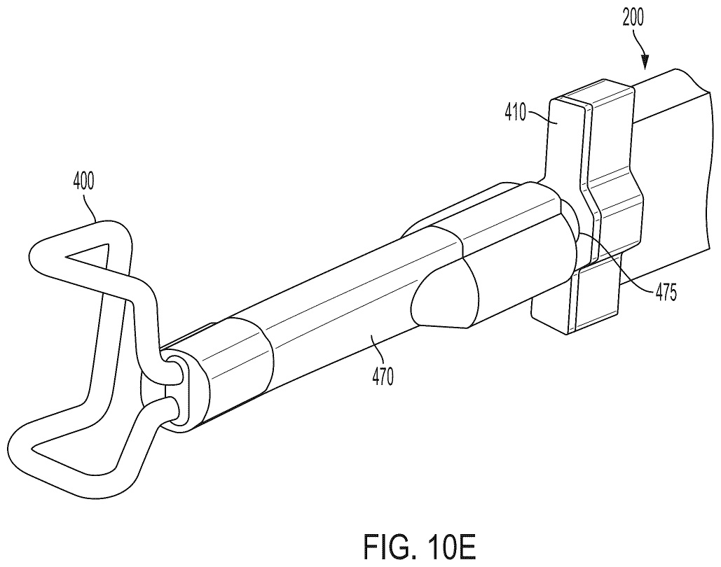

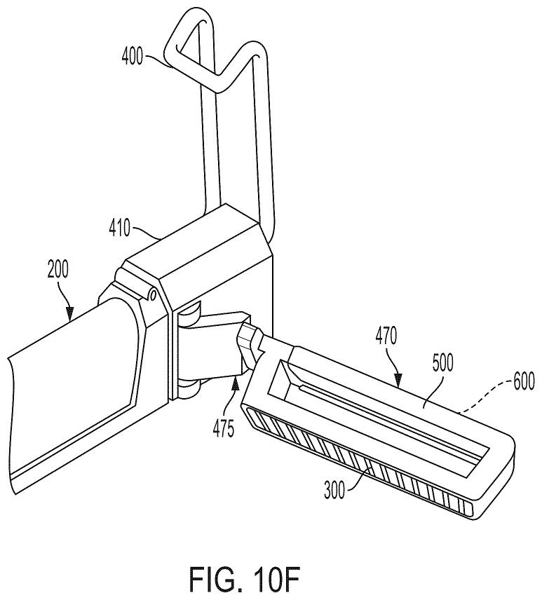

Example work lights 100 may include light sources 300 wherein the lighting angle (that is, the direction of the LED light elements with respect to hooks 400) is adjustable and/or may be adjusted by using its housing 500 and/or a grab handle 470, e.g., as shown in FIGS. 10E and 10F. In this example embodiment, the body 200 of the under-hood light 100 is rotatably adjustable with respect to the side hooks 400 and object, e.g., vehicle hood, to which it is attached.

Persons working in an engine compartment or other dirty automotive part usually have hands that become covered in oil, grease and other slimy substances that if they were to come into contact with the light sources 300, will degrade the quality and intensity of the light available therefrom. If the person using the light touches and adjusts the light by grabbing the body (housing) 200 of the light, that part of the light which includes its light sources 300 will become more and more obscured by the substances that transfer from the user's hands, and light from that part of the light source will degrade unless the light 100 and its light source 300 are cleaned frequently, which is inconvenient and reduces work efficiency.

Light 100 may include a handle or other form of grab point, apart from the light source 300, to allow the user to adjust the angle of the light source 300 without touching the surface of the light itself. Housing 510 of light 100 in the illustrated example embodiment provides such handle or grab point, however, a separate handle may be provided, e.g., on one or more housings 200. Such handle may be pivotable to be adjacent to housing 200 to provide a convenient carrying handle and be pivotable away from housing 200 to facilitate it being gripped and moved to rotate housings 200 and light sources 300 thereon relative to hooks 400 which have a rotatable attachment 440 to housing 200.

The foregoing embodiment of light 100 having a spring joint 240 may employ any of the configurations of light sources 300 and any of hooks 400 described herein as well as other

FIGS. 10A through 10D illustrate alternative example embodiments of hooks 400 that are convenient for stowing the example work light 100, and FIGS. 10E and 10F are illustrations of hooks 400 having an associated handle 475 for the example light 100. Another desirable feature of the design of the work light 100 described herein is the foldability or stowability of the light's hooks 400, which provides an advantage beyond the primary function of the hooks to grasp the edge of a vehicle hood or other object, without damaging the paint or underlying metal surfaces, and supporting the weight of the light.

To accomplish the basic grasping function, most prior art devices use simple hooks or brackets made from a rigid material and coated with a protective padding or other surface to avoid damage to painted metal hoods. Some prior art devices provide for rotating each hook so that, when the light is attached to the vehicle hood at varying angles or positions, the body of the light may be rotated with respect to the hooks, and the structure to which it is mounted, allowing the light to be aimed at the relevant work area without directing glare into the user's eyes.

These prior art hooks ignore at least one consideration for the hooks, namely, using the hooks 400 to improve the folding and storage of the work light 100 when it is not in use. Therefore, it seems desirable to provide hook shapes and arrangements that allow the hooks 400 to be retractable and/or be used as a latch for locking together the two halves 220 of the work light 100 when the light is folded, e.g., for storage. Improved hooks 400 described herein may fold into a more compact shape than prior art designs, with the body of the hook 400 being shaped and formed so that it can be nested against the light body 200, 220, with the hooks closely adjacent to the housing, e.g., a housing 200 and/or connection 410.

FIGS. 10A and 10B illustrate an example embodiment of a hook 400 that is retractable into housing 200, 260 and that is rotatable and pivotable when deployed. Connector 410 at the end of housing 200, 260 includes a retainer 440 that is movable in a bore of connector 410 along the longitudinal direction of housing 200, 260 and that is also rotatable in that bore. When retainer 440 is retracted into housing 200, 260, hook 400 is drawn therein so that only the end thereof is exposed, and the end thereof can be within the cross-sectional size of housing 200.

Hook 400 is deployed by pulling hook 400 away from housing 200, 260 which pulls retainer 400 in a like direction into end connector 410, such movement in and out of the housing being indicated by the double-ended straight arrow. Once pulled out sufficiently to expose the pivotable connection 440P of the ends of hook 400 in the pivot 440P, hook 400 is pivotable to move towards being perpendicular to the longitudinal direction into a deployed use position. The rotatability of hook 400 is indicated by a circular double-ended arrow and the pivotability thereof by a curved double-ended arrow.

Hook 400 is returnable to the stowed condition, e.g., for storage or transport, by reversing the above steps regarding its being deployed, i.e. by aligning hook 400 with the housing 200, 260 and pushing it into the housing.

FIG. 10C illustrates an example embodiment of a hook 400 that is retractable into housing 200, 260 and that is rotatable and pivotable when deployed as described above. In this embodiment, when housing 200, 260 are folded to be adjacent to each other, one of hooks 400 which is on a first housing member 200, 260 is relatively wider and has a larger distal end such that it can be pivoted on connector 410 and retainer 440 to move over and enclose the other housing 200, 260, thereby retaining the two housing members 200, 260 in the folded position. To release the housings from being retained in the folded position, the larger hook 400 is pivoted away from housing 200, 260 towards its use position.

FIG. 10D illustrates another example embodiment of hooks 400 that are retractable into housing 200, 260 as in FIG. 10A. In this embodiment one or both hooks 400 include a latching element 402 configured to be movable toward the other hook 400 for engaging therewith to retain the hooks 400, and housings 200, 260 on which they are attached, in their folded position. Disengaging latch element 402 allows housings 200, 260 to be moved towards their use positions.

Hooks 400 configured as in FIG. 10D can also be used to enable additional uses the light 100 itself. This may include instances when it is desired to use the light while in the folded position. For example, while light 100 is in the folded position, the hooks 400 can extend outwardly and be retained, e.g., by a detent, relatively perpendicular to housing 200 to serve as “feet” 400 to help the light 100 to stand upright, e.g., vertically on a horizontal surface, to act as an area light. Or, the “feet” 400 can extend outwardly from housing 200 to help the light lay on its back on a relatively horizontal surface, e.g., to light up the underside of a vehicle or other work area. Hooks 400 can also be used to hang the work light 100 while it is in the folded or storage position and in some embodiments, in a fully or partially deployed position.

In this example, hooks 400 may be provided with small non-smooth features, e.g., triangular, interlocking latch pieces 402, or with other features, e.g., hook and loop fasteners, that act as a releasable fastener retaining the light 100 in the folded or stowed configuration.

The foregoing features are particularly useful when the spring joint 240 is, in some embodiments, biased towards an unfolded configuration, and so it is advantageous to include a latching or locking mechanism that is integrated into the existing parts of work light 100 to retain the two half housing members 220 of the light in a folded configuration and that is easily latched and unlatched without the need for complicated instructions or tools.

While a hook 400 having only one prong may be employed, it appears that hooks 400 having at least two spaced-apart prongs or having a relatively broad width are preferable because they can provide a wider and more stable grip to an object, e.g., the edge of a hood, whereby light 100 tends to remain where it is placed.

Various handle arrangements may be utilized with light 100 as shown in FIGS. 13B and 13C. Example handle 470 of FIG. 10E extends from the end assembly 410 at the end of housing 200. Handle 470 may be supported by a rigid connection or by a rotatable and/or pivotable joint 475 so as to be movable relative to housing 400, as may be desirable or positioning light 100. Thus handle 470 is convenient for rotating housing 200 relative to hook 400, e.g., for aiming the light from light source 300 in a desired direction and may also be pivoted to be adjacent to housing 200 where it may be utilized to carry light 100 when in its collapsed or folded configuration.

Example handle 470 of FIG. 10F extends from the side of end assembly 410 at the end of housing 200 and supports hook 400 at its distal end. Handle 470 may be supported by a rotatable and/or pivotable joint 475 so as to be movable relative to housing 400, as may be desirable or positioning light 100.

Either example handle 470 may be configured to include a light source 300 so as to provide a positionable light source 300 at a distal end of light 100 that can directed in a desired direction by a user. In that instance, handle 470 is preferably supported by a pivotable and/or rotatable joint 475 for greater flexibility in being positioned to direct light in a desired direction. This handle 470 also includes an electrical power source for operating light source 300 as illustrated.

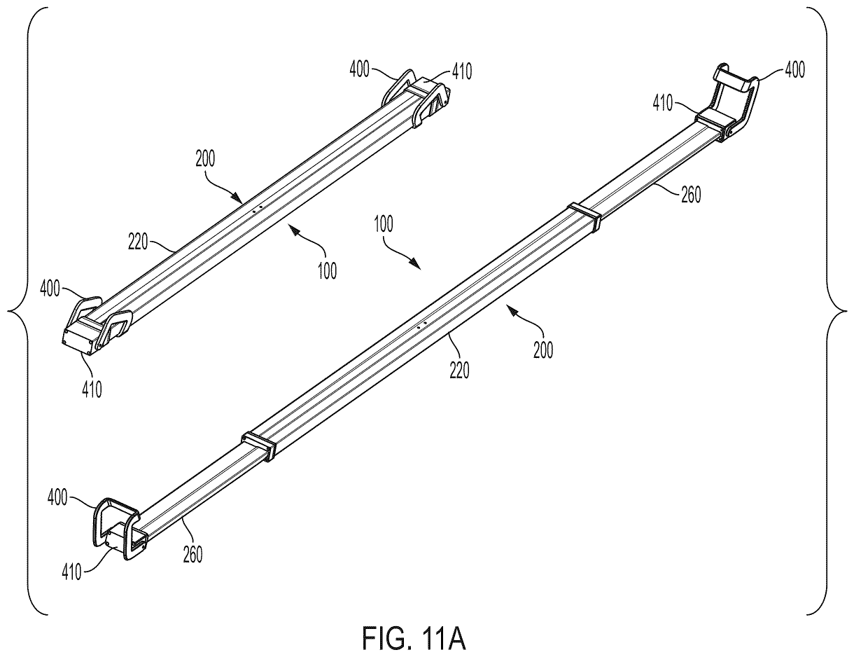

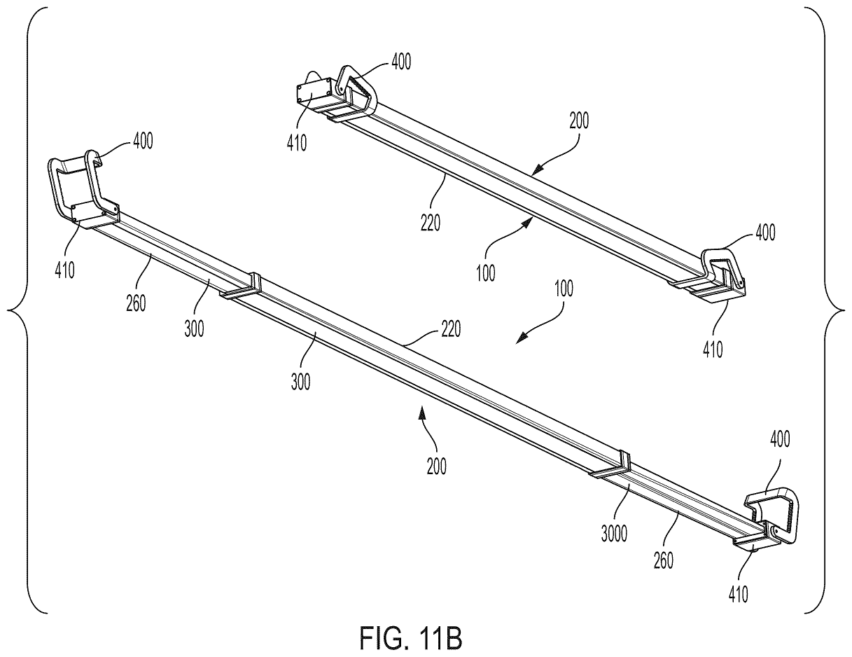

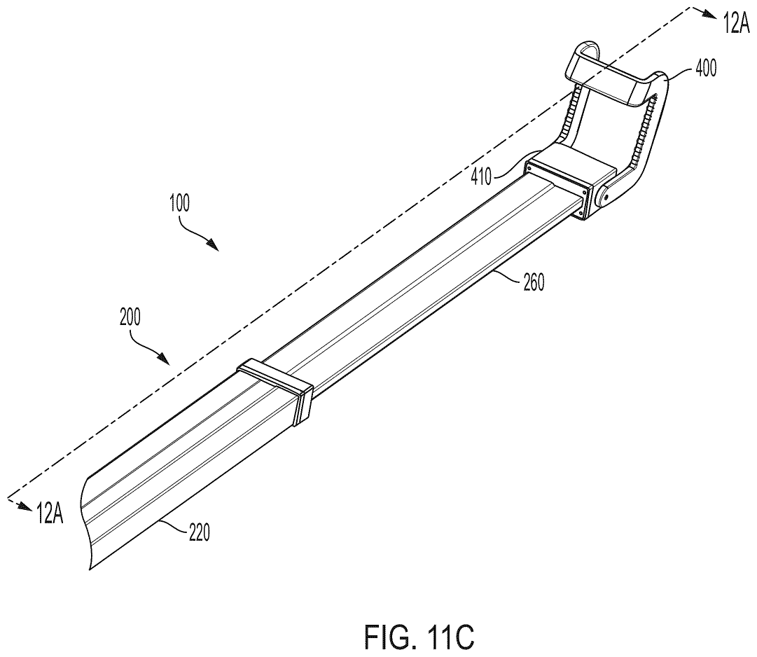

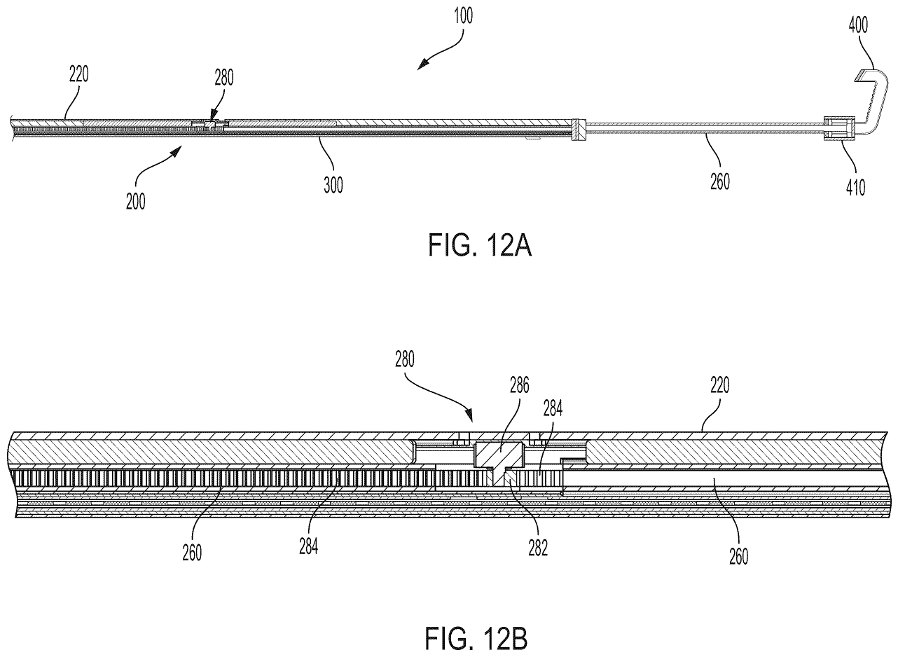

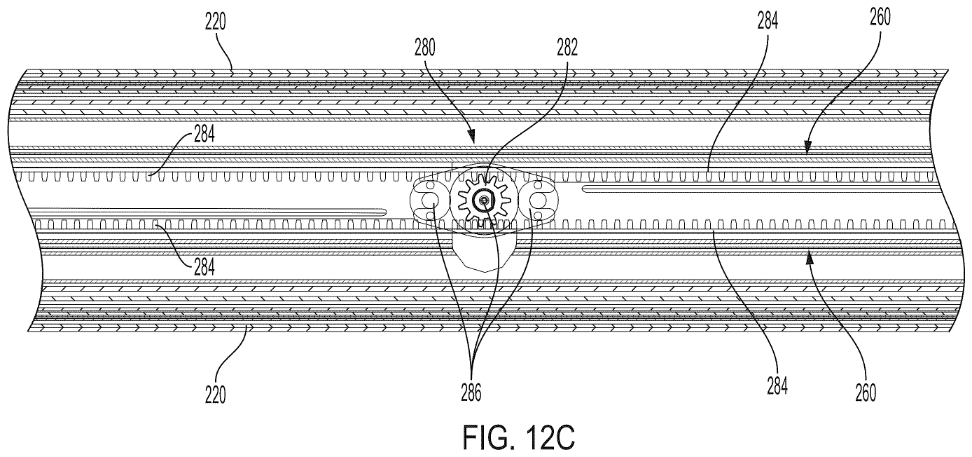

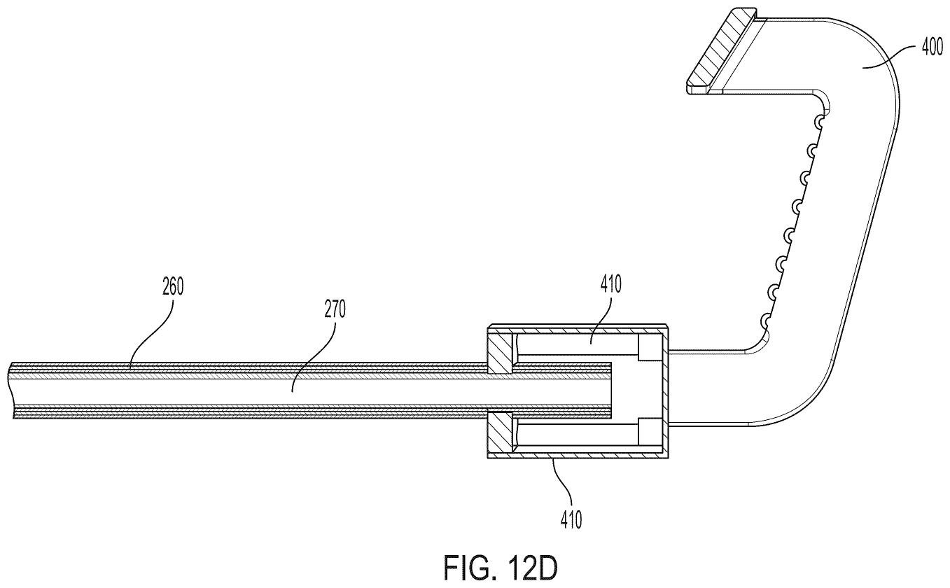

FIGS. 11A and 11B include perspective views of another example embodiment the work light 10 in collapsed and extended states; FIG. 11C is an enlarged perspective view of an end of the example work light 100; and FIGS. 12A through 12D are cross-sectional views of elements of the example work light 100 of FIGS. 11A-11C.

Work light 100 comprises a housing 200 which includes an elongated central housing member 220 and plural elongated extension members 260 that are movably disposed in central member 220 so that work light 100 can be extended for grasping a large object, e.g., an automotive hood or trunk, and can be collapsed for convenient storage and transport.

Housing 200 includes central housing member 220 that provides an elongated hollow housing for receiving therein plural extension members 260 which are movable therein so that the hooks 400 at the outer ends thereof are closer together in the collapsed state for storage and transport and are farther apart in the extended state for grasping an object to which work light 100 is attached for use. A biasing member 270 is attached to both of extension members 220 for moving them towards each other whereby they tend to be drawn together inside of central member 220, preferably symmetrically, which assists light 100 to clamp onto an object between hooks 400 and to retract when not grasping an object.

A hook or other grasping element 400 is provided at the distal ends of light 100 for grasping an object to which the light 100 is to be attached. Hooks 400 may include a cushion and/or padding as described herein. Hooks 400, functional equivalents thereof, and the like are as described herein and each may be attached by a connection device 410 to the distal end of an extension member 260, e.g., by an attachment arrangement and/or end assembly 410.

End assembly 410 may include, e.g., a fixed or a pivotable attachment 410 for hooks 400, which may or may not be biased to move the distal ends of hooks 400 towards the center of light 100. End assembly 410 may or may not include a user interface and the like that may include an electrical power source, actuators for the light source 300, and/or control circuitry as described herein, however, at least one such assembly 410 is usually preferred.

Light 100 may include one or more light sources 300 for directing light toward a workpiece to be illuminated by light 100. An example light source 300 is provided on a surface of central housing member 220 that faces toward such workpiece and one or more additional light sources may be disposed on similar surfaces or on extension members 260. Examples of light sources 300 and their configurations and operation are described herein, and any of the light sources described herein may be utilized with light 100.

In many conventional extendable lights the extendable parts thereof are independent of each other and so each must be extended independently in order to place the conventional light on a large object. As a result, the central part of such light may or may not be centered on the object to which it is attached. In addition, the light may be awkward for one person to utilize and/or may require assistance from a second person. Therefore it would seem advantageous to provide a light that operates symmetrically so as to be more convenient for a single person to utilize.

“A rack and pinion is a type of linear actuator that comprises a circular gear (the pinion) engaging a linear gear (the rack). Together, they convert between rotational motion and linear motion: rotating the pinion causes the rack to be driven in a line. Conversely, moving the rack linearly will cause the pinion to rotate.” “A single pinion can simultaneously drive two racks, parallel but opposite; which will always be displaced by the same distance, only in opposite directions. Conversely, by applying opposite forces to the two racks one can obtain pure torque on the pinion, without any force component.” [See, Wikipedia, “Rack and Pinion” at https://en.wikipedia.org/wiki/Rack_and_pinion].

Example work light 100 advantageously extends symmetrically in both directions simultaneously even when used by a single person. When one extension member 260 is pulled away from center housing 220, the other extension member 220 simultaneously moves away from center housing member 220 in the opposite direction so that both move outwardly together, thereby extending light 100. Likewise, when one extension member 260 moves into center housing 220, the other extension member 220 simultaneously moves into center housing member 220 so that both move inwardly together, thereby collapsing light 100, e.g., for storage or transport. Thus, both ends of light 100 move in complementary directions to either extend or collapse light 100 when either one of extension members 260 is moved relative to center housing 220.

Light 100 preferably includes an extension arrangement 280 that links and coordinates the relative movement of extension members 260 when light 100 is expanded and collapsed. To that end, extension mechanism 280 includes, e.g., the parts of extension members 260 that are proximate the center of light 100 with each including a linear gear 284, i.e. a rack 284, along the length thereof. The respective racks 284 of the extension members 260 are oriented to face each other for engaging a pinion gear 282. Further, within center housing member 220, preferably near the center thereof, e.g., substantially equidistant from the opposite ends thereof, is provided a rotatable pinion gear 282 that engages the respective racks 284 of extension members 260.

Thus, movement of either extension member 260 inwardly or outwardly relative to center housing 220 imparts through its rack 284 rotation of pinion gear 282 which imparts equal movement of the other extension member 260 in the opposite direction, so that both extension members 260 move inwardly or outwardly together simultaneously, symmetrically and in synchronism.

Center housing 220 further includes a support 286 for pinion gear 282, e.g., an axle, on which gear 282 can rotate while engaging the respective racks 284 of extension members 260 as light 100 is extended and retracted (collapsed). Support 286 affixes the location of pinion gear 282 relative to center housing 220 and light 100 so that extension members 260 can be extended and retracted symmetrically and simultaneously to maintain center housing 220 (and usually a light source 300 thereon) substantially at the center of the length of light 100 irrespective of its degree of extension or retraction, from being fully extended, e.g., for use, or completely retracted (collapsed), e.g., for storage and/or transport.

Extension members 260 are biased to move into center housing 220 by a biasing member 270, e.g., an elongated spring 270 or a bungee cord 270. Additionally or alternatively, pinion gear 282 may include a torsional spring that winds up with extension of elongated members 260 and exerts bias to retract those members 260. Alternatively, an individual biasing member 270 may extend from each extension member 220 to, e.g., pinion 282 or its support 286.

Additionally and/or alternatively, pinion 282 may include a damping mechanism so that when extension members 260 are released from an extended or deployed position, the force exerted on extension members 260 by biasing member 270 is moderated or slowed by the damping mechanism, thereby providing a “soft close” or “slow close” movement of the extension members 260 retracting in a controlled manner into housing member 220. Damping may be provided, e.g., by viscous damping, frictional damping and the like.

FIG. 13 illustrates an example of an alternative configuration of example work light 100 configured to utilize the hood striker HS and/or another vehicle part, and FIGS. 13A and 13B illustrate an example embodiment of a hood striker attachment arrangement 248 therefor. In these example arrangements, the opposing ends, e.g., hooks 400, of the work light 100 are not necessarily attached to the edges of the vehicle hood.

Even though attaching an under-hood light to the edges of the vehicle hood is apparently a preferred choice for all prior art devices, using a vehicle's hood edges to support a work light can still be problematic. The hooks at the ends of the work light can damage the paint or scratch the painted surface of the hood; if the spring tension of the light is too strong or the light is too heavy, the hooks may even slightly bend the edges of the hood. Also of concern is the location in the workspace where most of the light is concentrated.

The example embodiment of work light 100 now described, however, advantageously enables the user to attach the work light 100 to the hood striker HS at the front end of the hood or to another part of the vehicle, e.g., to a hood hinge part or to a hose or tube. Most vehicles have a hood striker HS that is of substantially the same shape, i.e. that of a generally rectangular flat metal loop attached at the center front underside of the hood.

The hood striker HS provides an alternative point for attaching one end or another part of the under-hood light 100. Light 100 can be attached to the hood striker without any fear of damaging paint or metal surfaces of the hood. The other end (or ends) of the hood light can be attached to the hood hinge hardware near the bottom rear corners of the hood, or the light 100 can have a padded hook 400 for attaching the other end of the light to the rear or other edge of the raised hood. In some embodiments, light 100 may be attached to a hood striker HS alone, without additional hooks or attachment to other part of the vehicle or other object to which light 100 is

As illustrated in FIG. 13, this attachment arrangement provides for more light to be directed towards the center of the engine compartment, where more of the work is likely to be occurring, and also provides for light to be emitted from a location that is much closer to the engine compartment and/or the engine, because the light's LED light sources 300 are positioned in areas that extend much lower on the underside surface of the vehicle hood.

The versatile nature of the connector 248 in combination with hooks 400 allows for the light 100 to be attached to any number of edges, surfaces, tubes, supports, etc that are present inside the engine bay.

The advantage thereof is that the user does not have to attach light 100 to the hood edge itself, although that option remains should another suitable option not be available. Keeping the attachment points for light 100 off the hood and enabling attaching light 100 inside the engine bay may be attractive to automotive technicians who do not want to risk scratching or causing other cosmetic damage to surfaces of the vehicle.

Even greater flexibility in positioning the light sources 300 of light 100 as illustrated in FIG. 13 is provided when light 100 includes one or more deployable light sources 300 as illustrated in FIGS. 4A-4B which may be utilized on any of the lights 100 described herein. That light source 300 includes a multi-pivot ball joint assembly that can augment the flexibility or positions afforded by connector 248 for the work light 100. The multi-pivot assembly allows for significant articulation and adjustment of the positions of light sources 300 of housing members 200 of light 100, as shown by the plural example positions into which light source 300 may be moved in FIG. 13. The multi-pivot assembly could also have an extendable member for additional manipulation.

A connector 248 for so utilizing the hood striker HS or another vehicle part as illustrated in FIGS. 13A and 13B provides a pair of opposed movable arms 248A that can be opened to be attached to the hood striker HS and latched closed to grasp hood striker HS and/or any other suitable part of the vehicle. Connector 248 may be permanently attached to or part of light 100 as illustrated or may be configured to be attachable to and removable therefrom.

Connector 240 includes a pair of opposed pivotable arms 248A that pivot apart for being placed onto and grasping hood striker HS and/or pivoted apart for releasing hood striker HS. The ends of connector arms 248A are preferably hooked to enclose hood striker HS and may have angled distal ends as illustrated so that connector 248 may be attached to hood striker HS by being pushed against hood striker HS causing arms 248 to separate and then close to grasp hood striker HS when the hood striker advances between arms 248A.

Arms 248A are preferably biased to move to a closed or latched position, e.g., by a spring 248S, that is compressed by the opposite ends of arms 248A when their distal ends are moved apart. Arms 248A may have extensions 248B that provide “buttons” that can be pressed together to overcome the bias of spring 248S and open the distal ends of arms 248A for attaching connector 248 to a hood striker HS or to any other suitable part of a vehicle or other object to which light 100 is to be attached.

In this example, connector arms 248A are illustrated as being supported by a member 200 which could be any desired part of a housing 200. Alternatively, arms 248A can be supported by a bracket by which connector 248 may be attached to light 100 at a location convenient to a user in a given situation. Such bracket can hook or clip or clamp to housing 200 and/or any part or parts thereof. In the example of FIG. 13, connector 248 has a hook or loop through which an example spring connector 240 may pass.

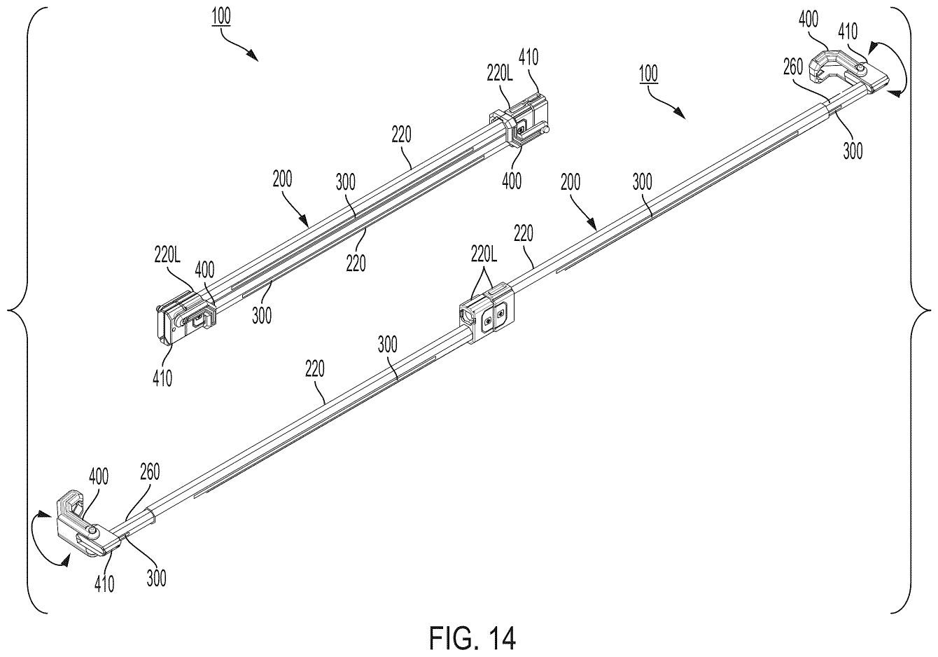

FIG. 14 includes perspective views of the example work light 100 in collapsed and extended or deployed states.. This example embodiment of a work light 100 may have certain advantageous features including a relatively long extended length for being attached to wide objects and a relatively shorter compressed and compact length for convenient storage and transport.

This embodiment of an example work light 100 has a sliding beam housing 200 configuration wherein the outer housing members 220 of the light do not fold and there is no center joint. The outer housings 220 slide parallel to each other while being engaged and supported by guide pieces or tracks 200L. Engaging features 200L allow the light, e.g., members 220, to be compressed for storage and then extended or deployed to different lengths to be attached to a variety of different vehicle hoods and other objects. Since there is no hinge in the center, the light 100 tends to be relatively rigid and will resist “sag” at its center when suspended in a hanging

The hooks 400 for this example embodiment are rotatable and/or pivotable relative to the central longitudinal axis and may be shaped so that, in a storage configuration, the hooks 400 fold to be close to members 220 and/or assist in locking together the two outer housings 220 of the light. In the illustrated arrangement, hooks 400 are configured to stow closely to members 200, 220 and so are rotated and/or pivoted when being deployed into orientations consistent with the direction in which light sources 300 are deployed. This embodiment is thought to have the advantage of being particularly simple in form, with fewer parts and manufacturing steps than does a hinged configuration, which can reduce manufacturing costs.

Work light 100 comprises a housing 200 having two or more housing members 220 disposed in a side-by-side slidable configuration, which provides for rigidity and robustness. Work light 100 may also have extension members 260 for further extending the length of light 100 when fully deployed. Members 220 and/or 260 are biased to retract into a collapsed configuration with members 220 side-by-side for storage and/or transport. Members 220 and/or 260 may be of any suitable configuration, e.g., as described herein, including being elongated members having a steel strip along a side thereof for having detachable lights as described.

Any one or more of the housing members 200, 220, 260 may have an elongated light source 300, e.g., an LED strip light 300, disposed along its length, such that all direct light in a common general direction. Detachable light sources 300 may also be utilized therewith.

Each housing member 220 and/or extension member 260, if present, may have an end assembly 500, 600 attached at one end thereof that includes a user interface 500 having a power actuator 520 and including a receptacle and power source 600 therein. In one configuration the housing 510 of user interface 500 may include the engaging member 200L that slidably engages the other housing member 220 for extension and retraction, whereby the two housing members 220 are longitudinally movable as they slide along side each other in their respective engaging members 200L for extending and retracting light 100.

The housing members 220 may have, e.g., an octagonal cross-section, but they may be circular or oval or of another desired cross-sectional shape, although a non-symmetrical cross-section is preferred. One or more LED light sources 300 are disposed along the length of housing members 220, e.g., on one or more of the flat surfaces thereof. Work light 100 can be extended, e.g., up to about 80 inches (about 203-204 cm) for being attached to objects, e.g., vehicle hoods and/or truck hoods, and can be retracted to about 32 inches (about 81-82 cm) of about 32-80 inch (about 81-204 cm) in width for compact storage and transport.

In one arrangement, two independent light sources 300 are provided that are independently operable and that have separate user interfaces 500 and power sources 600, e.g., rechargeable batteries, thereby providing further flexibility to accommodate a wider range of user needs in a wider variety of situations and environments. Alternatively, a single user interface 500 may be provided so that either and both light sources 300 can be controlled thereby, or each of the two user interfaces 500 can be configured to control either and both of light sources 300, thereby also providing flexibility to accommodate a wider range of user needs in a wider variety of situations and environments.

The respective housing members 220 each includes an end assembly 500, 600 at one end thereof and each end assembly 500, 500 may include the engaging feature 200L that slidable engages the other housing member 220, thereby enabling the slidable extending and retracting of light 100. In this example, a connection 410 at the end of housing member 220 or 260 that is distal from the end assembly 500, 600 thereof attaches hook 400 to housing member 220 or 260 and hook 400 is rotatable and/or pivotable about the longitudinal axis of housing member 220 for providing clearance for accessing power source 600, e.g., to replace the one or more batteries 610 therein.

Each end assembly or connector 410 may include a user interface 500 and/or a power source 600, supports a hook 400 that is pivotably mounted thereto by connector 410 so as to be deployable for use in engaging an object to which light 100 is to be attached, e.g., for use and is stowable for easing storage and transport. A release button or a detent may be provided to retain hook 400 and/or connector 410 “clicked” into its stowed position. Advantageously, hook 400 may be configured not only to facilitate attaching work light 100 to a work object, e.g., a vehicle hood, but also to have a minimal and compact profile when stowed so as to facilitate storage and avoid hooking light 100 on an object when that is not desired.

The electrical power source 600 and user interface 500 for this work light 100 can be configured differently in this example embodiment. One example thereof includes two separate batteries, one inside each housing member 220, coupled to separate user interfaces 500 such as, e.g., a power actuator 520 and charging port 570. In this arrangement, each member 220 is treated separately from an electrical circuit standpoint. While this arrangement would increase manufacturing costs, it can provide dramatically increased runtimes so that work light 100 is operable for an entire work shift.

Additionally, if only one end of light 100 needs to be running in order to perform a particular task or tasks, then the end user has that option. Another example embodiment could include one battery 600 and user interface 500. For example, the electrical circuitry could be configured such that when light 100 is in the collapsed position, the light source 300 of only one housing member 220 would provide light which may be advantageous for certain uses where lighting from the entire length of work light 100 is not necessary.

Light sources 300 of both housing members 220 may be configured to be energized to provide light only when electrical contact is achieved between the two members 220 when they are fully extended. This functionality can be achieved by utilizing pogo pins or similar electrical contacts on the two ends which will touch in the middle when the housings 220 of light 100 are fully extended, or by sliding contacts thereon, thereby to make an electrical connection between the circuits of the first and second housing members 220.

Sliding electrical contacts may be provided along all or part of the lengths of housing members 220 which allows the power source 600, user interface 500, and all needed electronics to reside in one housing 220 of light 100 and to be connected to the light sources 300 of both housing members 220. The sliding contacts allow for electrical connectivity between the first and the second light housings 220 and their respective light sources 300. Advantageously, either or both light bars may be energized when light 100 is in any configuration, e.g., whether it is stowed, fully extended, or in any other position in between, while requiring only one power source 600 and user interface 500.

Electrical power source 600 can be configured to accept single use and/or rechargeable batteries, and a charging port 620 can be provided on user interface and/or power source 600 for enabling the one or more batteries therein to be charged while in light 100. Such charging port also enables light 100 to be operated while connected to an external source of electrical power, if an when available, thereby greatly extending its operating time under those conditions. The external source of electrical power can include e.g., the battery of the vehicle being worked on or of another vehicle, as well as on-site common USB power outlets and/or AC power outlets.

Work light 100 further provides a flexible and adaptable light that lends itself to including various alternative sources of electrical power 600 for powering the example work light. Lights 100 may include an internal source of electrical power, like a rechargeable Li-ion battery, and/or a port or connector for receiving electrical power from an external source, like a USB-C port located somewhere on the exterior of the light.

Some batteries internal to a light may not be physically capable of carrying sufficient electrical charge to light an under-hood light at an acceptable level of illumination for eight continuous hours. One solution for keeping an under-hood light active for this length of time may require an external source of power.

But providing external power to an under-hood light using a typical power cord attached to a wall outlet is highly disfavored, since any cords connecting the light to a typical wall outlet, power strip or extension cord can constitute a tripping hazard, which is dangerous in an automotive repair or other work shop and/or operate at a higher voltage that is dangerous in that environment having exposed metal parts, some with sharp edges. Thus, providing an external source of power to the under-hood light without requiring a cord that extends into areas where mechanics are walking would be advantageous.

In order to accomplish operation over a full work shift (e.g., eight hours of continuous lighting), one alternative is to provide an electrical adapter to connect the under-hood light to the vehicle's battery. Such electrical adapter reduces or converts the voltage of the vehicle battery and the current to a voltage and current that is compatible with the electrical circuitry of work light 100, and has a plug or other connector for connecting that adapter to the work light, e.g., into the USB-C port of the light. Another alternative is to provide an electrical adapter to provide the ability to plug the work light into a USB port or another power outlet in the interior and/or console of the vehicle. tripping hazard is to connect the light to an external power cord that connects a USB-C port or other connector on the light to the terminals of the car's battery, which are ordinarily are present and easily accessible in the same work area as the light itself. Connecting the car battery to the under-hood light would involve, preferably, two electrical connector spring-biased “alligator” clamps or comparable connectors that respectively connect to the positive and negative terminals of the car battery, an electrical control circuit, e.g., adapter, to reduce the voltage and control the current from the battery to levels appropriate for the under-hood light.

Preferably, such adapter senses for and protects against short circuits, overloading, incorrect polarity and other errors in attaching the battery clamps. The adapter also includes or is compatible with an electrical cord of appropriate length to connect the electrical power from the electrical control circuit to the USB-C port or connector of the light. A power cord connecting the car battery to the under-hood light would not constitute a tripping hazard for the mechanic, since the cord in this configuration is entirely confined to the under-hood work area and does not extend to the floor and walls surrounding the vehicle.

Another option for providing an external source of power to the under-hood light without creating a tripping hazard is to connect an external power cord from a USB-C port on the light to a USB-C or USB-A port or another electrical power outlet located in the automobile's interior. Many cars include a USB-A and/or a USB-C port to deliver electrical power to devices in the car's interior, and in some cars, this port is active and delivers power even when the car's engine is switched off. So connecting a power cord between a USB port in the car's interior and the USB-C port on the light would be a practical way to deliver sufficient power to the under-hood light to remain lit for an entire 8-hour shift without presenting a tripping hazard to the mechanic.

It is noted that while the work light described herein may commonly be used in an environment of the engine compartment of a vehicle, or in another environment that is covered by a hood or by another cover, the present light is suitable for use in many different environments and is not limited to “under hood” uses, including both “work” and “non-work” uses, even though it may sometimes be referred to as an “under-hood” light and/or as a “work light.” and may comprise, e.g., suitable tubes or extrusions, and may include a steel strip 220S, 260S as described herein. Also, any of the light sources 300 and/or hooks 400 described herein may be utilized with any embodiment of a light 100 herein.

In a typical embodiment, various parts, e.g., housings 200, 220, 260, 510, and the like may be a metal or may be a nylon, reinforced nylon, engineered nylon, nylon 6, nylon 66, polyamide, polyamide 66, reinforced polyamide, reinforced polyamide 66, acrylonitrile butadiene styrene (ABS), polycarbonate, polyethylene, polypropylene, polycarbonate, polyester-polycarbonate blend, ABS polycarbonate blend, or other suitable plastic material, or of a cast, molded, forged, extruded, or machined metal. Resilient and/or flexible parts, such as, e.g., biasing member 270 and resilient padding 430, may be of any suitable flexible and/or resilient material, e.g., rubber, neoprene rubber, elastomers, thermoplastic elastomers (TPEs), silicones, urethanes, MONOPRENE® rubber, nylon-bondable SANTOPRENE® rubber, HERCUPRENE rubber, NYLABOND® TPE over-molding material, AuroraFlexTM TPE over-molding material, and other suitable materials. For example, preferred rubber and elastomer over-molding materials should chemically bond to a molded base material, e.g., nylon 6, glass-reinforced nylon 6 and blends of nylon 6 and nylon 6/6, without requiring a primer that would complicate the molding process, e.g., a two-step molding process.

Metal parts, such as the housings 200, 220, 240, 510, telescoping body parts 220, 260, springs 240 and fasteners, may be of any suitable metal, e.g., aluminum, steel, spring steel, ferritic steel, stainless steel, metal wires, brass, bronze, phosphor bronze, magnesium, beryllium copper, and the like. Where a part provides heat sinking, e.g., housings 200, 220, such may include a relatively highly thermally conductive material such as aluminum, brass, copper, magnesium, cast metal, and/or a plastic filled with thermally conductive particles, e.g., a thermally conductive reinforced nylon, engineered nylon, acrylonitrile butadiene styrene (ABS), polycarbonate, polyethylene, polypropylene, polycarbonate, polyester-polycarbonate blend, ABS polycarbonate blend, or other suitable thermally conductive plastic material, e.g., a plastic that includes (is filled with) thermally conductive particles, flakes, strands or other thermally conductive material, as well as other materials having suitable strength and thermal conductivity.

In a typical embodiment, lights 100 are desired to span a range of gripped objects from about 48″ (about 120-125 cm) wide to about 84″ wide (about 230-235 cm), which is believed to encompass a majority of popular passenger vehicles and trucks, however, lights 100 may have shorter or longer spans.

A light for illuminating a work space may comprise: plural elongated members movably disposed to be movable into deployed and collapsed positions, each having a distal end; one or more of the elongated members having an elongated steel strip along one elongated surface thereof; one or more detachable light sources that are attachable to the plural elongated members; respective hooks fastened to distal ends of two of the plural elongated members. The light for illuminating a work space may further comprise a connection configured to connect the plural elongated members. The connection may include: a spring connection between the first ends of the elongated members; or a spring and drag chain connection between the first ends of the elongated members; or a spring connection including an exoskeleton member 246-skeleton between the first ends of the elongated members; or a spring connection between the first ends of the elongated members and a tubular member slidable on the elongated member to cover the spring connection; or a pinion gear engaging a rack gear on two elongated members; or a loop on each of at least two adjacent elongated members, each loop engaging the other elongated member for adjacent sliding movement. The light for illuminating a work space wherein the plural elongated members are configured: to telescope one inside another; to be adjacent to each other in sliding relationship; to be foldable one adjacent to the other; or a combination of the foregoing. The light for illuminating a work space wherein one or more of the elongated members includes an extrusion formed to define a track along one elongated surface thereof and having the elongated steel strip in the track along the one elongated surface. The one or more detachable light sources may each include: a magnet, a clip, a clamp, a hook, a bracket or a combination thereof configured for attaching the detachable light source to the plural elongated members. The hooks may be configured to: be rotatable c a longitudinal axis of the elongated member; be pivotable relative to a longitudinal axis of the elongated member; be rotatable and pivotable relative to a longitudinal axis of the elongated member; retain two or more of the elongated members adjacent each other; latch one to another; provide a handle; provide a lighting device; provide feet for the light; or a combination of the foregoing. The light for illuminating a work space may further comprise a user interface and an electrical power source supported by one or more of the elongated members. The light for illuminating a work space may further comprise a biasing member attached to one or more of the elongated members for moving the elongated members towards the collapsed position. The light for illuminating a work space may further comprise: an elongated extension member slidably disposed in at least one of the elongated members and defining the second end of the extension member; and a biasing member for moving the extension member into the elongated member towards the collapsed position. The light for illuminating a work space may further comprise: a hood striker connector; or a hood striker connector that releasably grasps to a hood striker. The one or more detachable light sources may include: a fixed position light source; an adjustable light source including a pivotable joint; an adjustable light source including a ball and socket joint; an adjustable light source including a gooseneck stalk; or a combination thereof. The light for illuminating a work space further comprising: an elongated light source on one or more of the plural elongated members; a pivotable elongated light source on one or more of the plural elongated members; a deployable elongated light source on one or more of the plural elongated members; a deployable and aimable elongated light source on one or more of the plural elongated members; or an aimable elongated light source including a ball and socket joint on one or more of the plural elongated members; or a combination thereof.

A light for illuminating a vehicle having a hood striker may comprise: a light source; and a latch configured for grasping and releasing a hood striker. The latch may comprise: a pair of opposing pivotable arms having ends that close to grasp the hood striker and that separate to release the hood striker. The latch may further comprise: a biasing member urging the pivotable arms to grasp the hood striker.

A light for illuminating a work space may comprise: a pair of elongated housings each having a first end and a second end; a light source on an exterior surface of at least one of the housings; a coil spring fastened to the respective first ends of the housings; and first and second hooks fastened to the respective second ends of the housings. The coil spring may be tensioned to compress itself. The coil spring is fastened to respective ends of the housings by a friction fit, an interference fit, an adapter, or a fastener. At least one of the elongated housings may include: an outer housing member that provides the first end of the elongated housing, that is hollow, and that supports the light source; an inner extension member movable in the outer housing member and that supports one of the first and second hooks; and a biasing member that biases the inner extension member to move into the outer housing and towards the coil spring. Each of the elongated housings may include: an outer housing member that provides the first end of the elongated housing, that is hollow, and that supports the light source; an inner extension member movable in the outer housing member that supports one of the first and second hooks; the light may further comprise a biasing member connected to the inner extension members of each elongated housing that biases the inner extension members to move into the respective outer housings and towards the coil spring. The biasing member: may be attached to each of the inner extension members at the respective ends thereof that are distal the coil spring; or may be a bungee attached to each of the inner extension members at the respective ends thereof that are distal the coil spring. The light may further comprise an electrical power source supported by one of the elongated housings. The electrical power source may include: a lithium battery; or a rechargeable lithium battery; or a lithium battery having a USB connector for receiving charging power; or an electrical connector for connecting to an external source of electrical power; or a combination thereof. The light may further comprise a user interface supported by one of the elongated housings, the user interface including one or more actuators for controlling energizing of the light source. The one or more actuators control: turning the light source ON and OFF; or selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof; or turning the light source ON and OFF and selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof. The light source may be elongated and include: a plurality of packaged light emitting devices mounted on the exterior surface of one or both of the housings; or a plurality of packaged light emitting devices on an elongated substrate on one or both of the housings; or a plurality of light emitting chips mounted on an elongated substrate on one or both of the housings. The elongated substrate may include an electronic circuit responsive to one or more actuators for: turning the light source ON and OFF; or selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof; or turning the light source ON and OFF and selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof. The elongated light source may include a transparent or translucent lens covering the light emitting devices or diodes thereof, the lens being attached to the substrate or being a conformal lens formed on the substrate. The hook may include: a rigid hook structure; or a rigid hook structure covered by a resilient pad. a rigid hook structure in the form of a loop; or a rigid hook structure in the form of a loop and covered by a resilient pad. The hook may be: rotatable about a long axis of the elongated housing; or pivotable relative to the long axis of the elongated housing; or rotatable about and pivotable relative to the long axis of the elongated housing. The light may further comprise: a second light source on the exterior of the other one of the pair of elongated housings. The light may further comprise: a variable frequency pulse-width-modulated (PWM) drive signal for the light source. The coil spring may comprise: plural coil springs side-by-side; or one or more coil springs of non-circular cross-section; or an exoskeleton member; or a drag chain exoskeleton member. The light source may include a spot light or a lens slidable on the housing member to intensify the light into a spot beam. The coil spring may be slidably fastened to the respective first ends of the housings and/or may be enclosed within the respective first ends of the housings when the respective first ends of the housings are attached to each other.

A light for illuminating a work space may comprise: plural elongated housings disposed side-by-side, each having a first end and a second end; a light source on an exterior surface of at least one of the elongated housings; an end assembly at the first end of each of the plural elongated housings, each end assembly including an engaging member for slidingly engaging another of the elongated housings; and first and second hooks fastened to the respective second ends of at least two of the elongated housings. At least one of the elongated housings may include: an outer housing member that supports the light source; an inner extension member movable in the outer housing member and that supports one of the first and second hooks; and a biasing member that biases the inner extension member to move into the outer housing member. At least one of the end assemblies may include a user interface including one or more actuators for controlling energizing of the light source. The one or more actuators may control: turning the light source ON and OFF; and/or selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof. The light may further comprise an electrical power source supported by one of the elongated housings. The electrical power source may include: a lithium battery; or a rechargeable lithium battery; or a lithium battery having a USB connector for receiving charging power; or an electrical connector for connecting to an external source of electrical power; or a combination thereof. The light source may be elongated and may include: a plurality of packaged light emitting devices mounted on the exterior surface of one or both of the housings; or a plurality of packaged light emitting devices on an elongated substrate on one or both of the housings; or a plurality of light emitting chips mounted on an elongated substrate on one or both of the housings. The elongated substrate may include an electronic circuit responsive to one or more actuators for: turning the light source ON and OFF; and/or selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof. The light source may include a transparent or translucent lens covering light emitting devices or diodes thereof, the lens being attached to the substrate or being a conformal lens formed on the substrate. The hooks may be: rotatable about a long axis of the elongated housing; or pivotable relative to the long axis of the elongated housing; or rotatable about and pivotable relative to the long axis of the elongated housing. The light may further comprise: a second light source on the exterior of another one of the plural elongated housings. The light may further comprise: a variable frequency pulse-width-modulated (PWM) drive signal for the light source. The light source may include a spot light or a lens slidable on the housing member to intensify the light into a spot beam.

A light for illuminating a work space may comprise: plural elongated housings each having a first end and a second end; a light source on an exterior surface of at least one of the elongated housings; one or more coil springs fastened to the respective first ends of the elongated housings; and first and second hooks fastened to the respective second ends of the housings. The one or more coil springs may include: one coil spring; or plural coil springs side-by-side; or one or more coil springs of non-circular cross-section; or an exoskeleton member; or a drag chain exoskeleton member. At least one of the elongated housings may include: an outer housing member that provides the first end of the elongated housing, that is hollow, and that supports the light source; an inner extension member movable in the outer housing member and that supports one of the first and second hooks; and a biasing member that biases the inner extension member to move into the outer housing member and towards the coil spring. The light may further comprise an electrical power source supported by one of the elongated housings. The electrical power source may include: a lithium battery; or a rechargeable lithium battery; or a lithium battery having a USB connector for receiving charging power; or an electrical connector for connecting to an external source of electrical power; or a combination thereof. The light source may be elongated and may include: a plurality of packaged light emitting devices mounted on the exterior surface of one or both of the housings; or a plurality of packaged light emitting devices on an elongated substrate on one or both of the housings; or a plurality of light emitting chips mounted on an elongated substrate on one or both of the housings. The elongated substrate may include an electronic circuit responsive to one or more actuators for: turning the light source ON and OFF; and/or selecting one or more operating modes for the light source, wherein the operating modes include: changing brightness, dimming, un-dimming, selecting ones of devices producing light of different colors, selecting ones of devices producing light, a flashing mode, a strobing mode, a safety mode, or a combination thereof. The elongated light source may include a transparent or translucent lens covering the light emitting devices or diodes thereof, the lens being attached to the substrate or being a conformal lens formed on the substrate. The one or more coil springs may be slidably fastened to the respective first ends of the housings and/or may be enclosed within the respective first ends of the housings when the respective first ends of the housings are attached to each other.

As used herein, the terms “about,” “approximate” and/or “approximately” mean that dimensions, sizes, formulations, parameters, shapes and other quantities and characteristics are not and need not be exact, but may be approximate and/or larger or smaller, as desired, reflecting tolerances, conversion factors, rounding off, measurement error and the like, judgment, and other factors known to those of ordinary skill in the art. In general, a dimension, size, formulation, parameter, shape or other quantity or characteristic is “about” or “approximate” or “substantial” or “substantially” whether or not expressly stated to be such. It is noted that embodiments of very different sizes, shapes and dimensions may employ the described arrangements.

Although terms such as “front,” “back,” “rear,” “side,” “end,” “top,” “bottom,” “up,” “down,” “left,” “right,” “upward,” “downward,” “forward,” “backward,” “under” and/or “over,” “vertical,” “horizontal,” and the like may be used herein as a convenience in describing one or more embodiments and/or uses of the present arrangement, the objects described may be positioned in any desired orientation and/or may be utilized in any desired position and/or orientation. Such terms of position and/or orientation should be understood as being for convenience only, and not as limiting of the invention as claimed.

As used herein, the term “and/or” encompasses both the conjunctive and the disjunctive cases, so that a phrase in the form “A and/or B” encompasses “A” or “B” or “A and B.” Likewise, a phrase in the form “A, B and/or C” or a phrase in the form “A and/or B and/or C” includes “A,” “B,” “C,” “A and B,” “A and C,” “B and C,” and “A and B and C.” In addition, the term “at least one of” one or more elements is intended to include one of any one of the elements, more than one of any of the elements, and two or more of the elements up to and including all of the elements, and so, e.g., phrases in the form “at least one of A, B and C” include “A,” “B,” “C,” “A and B,” “A and C,” “B and C,” and “A and B and C.”

As used herein, the term “predetermined” means determined in advance or before hand with respect to whatever the term pertains to. The term may be used with respect to a physical object or thing and/or with respect to an intangible thing, e.g., a signal or data, and the like. Examples thereof may include a fixed value, position, condition and/or limit, however, predetermined is not limited to a fixed value, position, condition and/or limit. A predetermined value, position, condition and/or limit may change or otherwise vary over time, over a sequence and/or over a randomized series of values, positions, conditions and/or limits.

As used herein, the term “plurality” means plural, two or greater in number of whatever the term pertains to, i.e. more than one. The term may be used with respect to a physical object or thing and/or with respect to an intangible thing, e.g., a signal or data, and the like. Examples thereof may include a fixed or movable thing, a fixed value, a changeable value, position, condition and/or limit, and the like.

As used herein, the terms “substantial” and “substantially” mean that the thing referred to as being “substantial” or “substantially” is sufficiently similar in form and/or function as to usable in the invention in a manner that is encompassed or suggested by the description and/or claims herein, and/or an equivalent thereof. The terms “substantial” and “substantially” can include and/or can be in addition to the meaning of the terms “about,” “approximate” and/or “approximately” herein.

As used herein “transverse” refers to crossing, lying across, being across, in a cross direction, or crosswise, whether perpendicularly or at an acute or obtuse angle, and to directions so arranged or configured. That arrangement can also be said to intersect or pass through or to have an intersection. With regard to things that are three dimensional, transverse can mean that they encompass a common volume where they intersect or that they do not have a volume in common. In general, the terms “transverse” and “lateral” as well as and “transversely” and “laterally” may be used interchangeably unless the context indicates otherwise.

A fastener as used herein may include any fastener or other fastening device that may be suitable for the described use, including threaded fasteners, e.g., bolts, screws and driven fasteners, as well as pins, rivets, nails, spikes, barbed fasteners, clips, clamps, nuts, speed nuts, cap nuts, acorn nuts, and the like. Where it is apparent that a fastener would be removable in the usual use of the example embodiment described herein, then removable fasteners would be preferred in such instances. A fastener may also include, where appropriate, other forms of fastening such as a formed head, e.g., a peened or heat formed head, a weld, e.g., a heat weld or ultrasonic weld, a braze, an adhesive, a clasp, a clip, a latch, and the like.

The term “battery” may be used herein to refer generally to a source of electrical power or electrical power source, as well as to an electro-chemical device comprising one or more electro-chemical cells and/or fuel cells, and so a battery may include a single cell or plural cells, whether as individual units or as a packaged unit. A battery is one example of a type of an electrical power source suitable for a portable or other device. Such devices could employ power sources including, but not limited to, fuel cells, super capacitors, solar cells, and the like, as well as an electro-chemical battery. Any of the foregoing may be intended for a single use or for being rechargeable or for both, and/or plural ones thereof may be combined into a battery pack or battery assembly or other such assembly or pack, and any, some or all thereof may be referred to herein under the general term battery.

Various embodiments of a battery may have one or more battery cells, e.g., one, two, three, four, or more battery cells, as may be deemed suitable for any particular device. A battery may employ various types and kinds of battery chemistry types, e.g., a carbon-zinc, alkaline, lead acid, nickel-cadmium (Ni-Cd), nickel-metal-hydride (NiMH) or lithium-ion (Li-Ion) or lithium-iron-phosphate or other Lithium battery type, of a suitable number of cells and cell capacity for providing a desired operating time and/or lifetime for a particular device, and may be intended for a single use or for being rechargeable or for both. Examples may include a three cell Ni-Cd battery typically producing about 3.6 volts, a four cell NiMH battery typically producing about 4.8 volts, a five cell NiMH battery producing about 6 volts, a Lithium battery typically producing about 3.5-3.7 volts, or a two-cell Lithium battery typically producing about 7 volts, it being noted that the voltages produced thereby will be higher when approaching full charge and will be lower in discharge, particularly when providing higher current and when reaching a low level of charge, e.g., becoming discharged. Various Lithium chemistries, e.g., Lithium-ion, LiFeO₄, LiFePO₄, and the like, may be suitable for use in a work light 100.

The term converter or DC converter is used herein to refer to any electronic circuit that receives at an input electrical power at one voltage and current level and provides at an output DC electrical power at a different voltage and/or current level. Examples may include a DC-DC converter, an AC-DC converter, a boost converter, a buck converter, a buck-boost converter, a single-ended primary-inductor converter (SEPIC), a linear regulator, a series regulating element, a current level regulator, and the like. The input and output thereof may be DC coupled and/or AC coupled, e.g., as by a transformer and/or capacitor. A DC converter may or may not include circuitry for regulating a voltage and/or a current level, e.g., at an output thereof, and may have one or more outputs providing electrical power at different voltage and/or current levels and/or in different forms, e.g., AC or DC.

As used herein “dual-fuel” refers to lights and electronic devices, e.g., lights, flashlights, lanterns and the like, that can be powered by two or more sources of electrical power, e.g., batteries, of two or more different sizes, types, and/or kinds, at different times and/or at the same time. “Dual-fuel” may also refer to assemblies and/or packages of power sources, battery assemblies and/or battery packs, that can receive or contain two or more sources of electrical power, e.g., batteries, of two or more different sizes, types, and/or kinds, at different times and/or at the same time.

While the present invention has been described in terms of the foregoing example embodiments, variations within the scope and spirit of the present invention as defined by the claims following will be apparent to those skilled in the art. For example, while the light emitting devices 320 of light source 300 are described, e.g., as light emitting diodes 320, which are the presently preferred light emitting device, other light emitting devices and/or light emitting materials, e.g., OLEDs, phosphorescent materials, and light emitting dots, may be utilized therein.

Elongated light source 300 may comprise a single light source assembly as illustrated or may comprise plural shorter light source assemblies placed in a line with each other.

Having plural light sources 300 can be advantageous where a number of lights 100 of different lengths are being manufactured and so using plural or modular shorter light sources can provide for the same light source modules being used on the lights of different lengths.

While the example electrical power source 600 described herein is disposed in the user interface housing 510 that attaches to a housing 200, 220, that power source can be disposed in a part of a housing 200 that is co-linear therewith. For example, where housing 200 includes a cylindrical tube, e.g., an outer housing member 220 is a tube and/or extension member 260 is a tube, or another part thereof provides a cylindrical cavity into which one or more cylindrical electrical power sources 600, e.g., cylindrical batteries 610, may be placed.

Outer housing 220 may had a generally “D”-shaped or an oval shape flattened on one side or another shaped cross-section that provides an elongated flat surface which is well suited for receiving an elongated light source 300 thereon. Further, one or more handles may be provided on light 100, e.g., one handle on each housing member 220, for more convenient positioning and/or transport.

A fastener may be provided proximate to hooks 400 to retain light 100 in the folded storage or transport configuration, such as hook-and-loop fasteners, a strap, or an elastic loop and the like, or hooks 400 can be configured to serve as such fasteners, e.g., to interlock to each other or to otherwise grip and retain housing 200 in its folded or collapsed configuration.

Where a spot light feature is provided, the spot light may be integral to light 100 or may be detachable from light 100 for illuminating a specific work area. Preferably, such spot light is configured to have a handle part, e.g., a generally cylindrical extension, for providing a grip and/or for containing a source of electrical power, e.g., a battery for the spot light while it is apart from light 100.

In addition to hooks 400 for attaching light 100 to, e.g., a part of a vehicle, light 100 can include a magnet for attaching light 100 to an iron or steel object, e.g., a part of a vehicle. The magnet may be integral to light 100 or may be detachable therefrom when not needed. When thee magnet is detachable, its attachment to light 100 may be configured for attaching to light 100 at plural locations along its length thereby to provide additional versatility for the user.

While certain features may be described as a raised feature, e.g., a ridge, boss, flange, projection, detent, or other raised feature, such feature may be positively formed or may be what remains after a recessed feature, e.g., a groove, slot, hole, indentation, recess, detent, or other recessed feature, is made. Similarly, while certain features may be described as a recessed feature, e.g., a groove, slot, hole, indentation, recess or other recessed feature, such feature may be positively formed or may be what remains after a raised feature, e.g., a ridge, boss, flange, projection or other raised feature, is made. In addition, where a raised feature engages a recessed feature, such as a cylindrical projection that engages a complementary receptacle, the relative positions of the raised and recessed features may be interchanged or other wise modified.

Each of the U.S. Provisional Applications, U.S. Patent Applications, and/or U.S. Patents, identified herein is hereby incorporated herein by reference in its entirety, for any purpose and for all purposes irrespective of how it may be referred to or described herein.

Finally, numerical values stated are typical or example values, are not limiting values, and do not preclude substantially larger and/or substantially smaller values. Values in any given embodiment may be substantially larger and/or may be substantially smaller than the example or typical values stated.
DOCX: ± ≤ ≥ ≈ Å μ ⊕ ⊖ ½ ¼ ⅓ $ ™ ® © § ✓ ✓ ASCHI ™ § © ® ° ± μ ¶ Å GRK: Aα Bβ ΓΔ Εε Zη Θθ Λλ Mμ Nν Ππ Pρ Σσ T Φφ Xχ Ψψ Ωω NTRFont: ( ) * + − < = >? [ ] ™ § © ® μ ¼ ½ ¾ Å @ ! ″ #$ % & ′ ( ) +− / @ ~ KYBDCAB: ™ ~ + − ! @ #$ % \hat{ } & * ( ) − _ =+ [ ] { } [EndTst].

1. A light for illuminating a work space comprising:
one or more elongated members having an elongated magnetic or magnetically receptive strip along one surface thereof;
one or more hooks attached to at least one end of the one or more elongated members; and
one or more detachable light sources having a magnetic or magnetically receptive base for attaching the light source to the elongated strip.

2. The light for illuminating a work space of claim 1 further comprising a connection configured to connect at least two of the one or more elongated members.

3. The light for illuminating a work space of claim 2 wherein the connection includes:
a spring connection between the first ends of the elongated members; or a spring and drag chain connection between the first ends of the elongated members; or
a spring connection including an exoskeleton between the first ends of the elongated members; or
a spring connection between the first ends of the elongated members and a tubular member slidable on the elongated member to cover the spring connection; or a pinion gear engaging a rack gear on two elongated members; or
a loop on each of at least two adjacent elongated members, each loop engaging the other elongated member for adjacent sliding movement.

4. The light for illuminating a work space of claim 1 wherein the one or more elongated members are configured:
to telescope one inside another;
to be adjacent to each other in sliding relationship;
to be foldable one adjacent to the other; or
a combination of the foregoing.

5. The light for illuminating a work space of claim 1 wherein one or more of the elongated members includes an extrusion formed to define a track along one elongated surface thereof and having the elongated steel strip in the track along the one elongated surface.

6. The light for illuminating a work space of claim 1 wherein the one or more detachable light sources each include: a magnet, a clip, a clamp, a hook, a bracket or a combination thereof configured for attaching the detachable light source to the plural elongated members.

7. The light for illuminating a work space of claim 1 wherein the hooks are configured to:
be rotatable relative to a longitudinal axis of the elongated member;
be pivotable relative to a longitudinal axis of the elongated member;
be rotatable and pivotable relative to a longitudinal axis of the elongated member;
retain two or more of the elongated members adjacent each other;
latch one to another;
provide a handle;
provide a lighting device;
provide feet for the light; or
a combination of the foregoing.

8. The light for illuminating a work space of claim 1 further comprising a user interface and an electrical power source supported by one or more of the elongated members.

9. The light for illuminating a work space of claim 1 further comprising a biasing member attached to one or more of the elongated members for moving the elongated members towards the collapsed position.

10. The light for illuminating a work space of claim 1 further comprising:
an elongated extension member slidably disposed in at least one of the elongated members and defining the second end of the elongated member; and
a biasing member for moving the extension member into the elongated member towards the collapsed position.

11. The light for illuminating a work space of claim 1 further comprising:
a hood striker connector; or
a hood striker connector configured to enable the one or more hooks to be attached to other than an edge of a vehicle hood; or
a hood striker connector that releasably grasps a hood striker; or
a hood striker connector that releasably grasps a hood striker to enable the one or more hooks to be attached to other than to an edge of a vehicle hood.

12. The light for illuminating a work space of claim 1 wherein the one or more detachable light sources include:
a fixed position light source;
an adjustable light source including a pivotable joint;
an adjustable light source including a ball and socket joint;
an adjustable light source including a gooseneck stalk; or
a combination thereof.

13. The light for illuminating a work space of claim 1 further comprising:
an elongated light source on one or more of the plural elongated members;
a pivotable elongated light source on one or more of the plural elongated members;
a deployable elongated light source on one or more of the plural elongated members;
a deployable and aimable elongated light source on one or more of the plural elongated members; or
an aimable elongated light source including a ball and socket joint on one or more of the elongated members; or
a combination thereof.

14. A light for illuminating a work space comprising:
plural elongated members movably disposed to be movable into deployed and collapsed positions, each having a distal end;
one or more of the elongated members having an elongated steel strip along one elongated surface thereof;
one or more detachable light sources that are attachable to the plural elongated members;
respective hooks fastened to distal ends of two of the plural elongated members.

15. The light for illuminating a work space of claim 14 further comprising a connection configured to connect the plural elongated members.

16. The light for illuminating a work space of claim 15 wherein the connection includes:
a spring connection between the first ends of the elongated members; or
a spring and drag chain connection between the first ends of the elongated members; or
a spring connection including an exoskeleton between the first ends of the elongated members; or
a spring connection between the first ends of the elongated members and a tubular member slidable on the elongated member to cover the spring connection; or
a pinion gear engaging a rack gear on two elongated members; or
a loop on cach of at least two adjacent elongated members, each loop engaging the other elongated member for adjacent sliding movement.

17. The light for illuminating a work space of claim 14 wherein the plural elongated members are configured:
to telescope one inside another;
to be adjacent to each other in sliding relationship;
to be foldable one adjacent to the other; or
a combination of the foregoing.

18. The light for illuminating a work space of claim 14 wherein one or more of the elongated members includes an extrusion formed to define a track along one elongated surface thereof and having the elongated steel strip in the track along the one elongated surface.

19. The light for illuminating a work space of claim 14 wherein the one or more detachable light sources each include: a magnet, a clip, a clamp, a hook, a bracket or a combination thereof configured for attaching the detachable light source to the plural elongated members.

20. The light for illuminating a work space of claim 14 wherein the hooks are configured to:
be rotatable relative to a longitudinal axis of the elongated member;
be pivotable relative to a longitudinal axis of the elongated member;
be rotatable and pivotable relative to a longitudinal axis of the elongated member;
retain two or more of the elongated members adjacent each other;
latch one to another;
provide a handle;
provide a lighting device;
provide feet for the light; or
a combination of the foregoing.

21. The light for illuminating a work space of claim 14 further comprising a user interface and an electrical power source supported by one or more of the elongated members.

22. The light for illuminating a work space of claim 14 further comprising a biasing member attached to one or more of the elongated members for moving the elongated members towards the collapsed position.

23. The light for illuminating a work space of claim 14 further comprising:
an elongated extension member slidably disposed in at least one of the elongated members and defining the second end of the elongated member; and
a biasing member for moving the extension member into the elongated member towards the collapsed position.

24. The light for illuminating a work space of claim 14 further comprising:
a hood striker connector; or
a hood striker connector configured to enable the one or more hooks to be attached to other than an edge of a vehicle hood; or
a hood striker connector that releasably grasps a hood striker; or
a hood striker connector that releasably grasps a hood striker to enable the one or more hooks to be attached to other than to an edge of a vehicle hood.

25. The light for illuminating a work space of claim 14 wherein the one or more detachable light sources include:
a fixed position light source;
an adjustable light source including a pivotable joint;
an adjustable light source including a ball and socket joint;
an adjustable light source including a gooseneck stalk; or
a combination thereof.

26. The light for illuminating a work space of claim 14 further comprising:
an elongated light source on one or more of the plural elongated members;
a pivotable elongated light source on one or more of the plural elongated members;
a deployable elongated light source on one or more of the plural elongated members;
a deployable and aimable elongated light source on one or more of the plural elongated members; or
an aimable elongated light source including a ball and socket joint on one or more of the plural elongated members; or
a combination thereof.

27-79. (canceled)
